(19) United States
(12) Patent Application Publication
(10) Pub. No.: US 2025/0234218 A1
(43) Pub. Date: Jul. 17, 2025

(54) Network Nodes and Methods in a Wireless Communications Network Technical Field

(71) Applicant: Telefonaktiebolaget LM Ericsson (publ), Stockholm (SE)

(72) Inventors: Pablo Soldati, Solna (SE); Luca Lunardi, Genova (IT)

(21) Appl. No.: 18/698,069

(22) PCT Filed: Sep. 28, 2022
(86) PCT No.: PCT/SE2022/050863

§ 371 Date: Apr. 3, 2024

Related U.S. Application Data
(60) Provisional application No. 63/262,695, filed on Oct. 19, 2021.

(51) Int. Cl. H04W 24/04; H04W 28/02

(52) U.S. Cl. CPC H04W 24/04; H04W 28/0226

(57) ABSTRACT

A method performed by a first network node for requesting a second network node to provide status information associated with a third network node in a wireless communications network is provided. The first network node requests (903) the second network node to provide status information by transmitting a first request message to the second network node. The first request message is indicative of one or more conditions for triggering the second network node to provide status information associated with the third network node when at least one of the one or more conditions is fulfilled. The first network node receives (904, 905) a message from the second network node. The message is indicative of any one out of: (904) A successful or partially successful initialization of a conditional forwarding configuration procedure, or (905) a status information associated with the third network node (113), based on that the at least one of the one or more conditions is fulfilled, or (904) an unsuccessful or failure to initialize the conditional forwarding configuration procedure.

### TECHNICAL FIELD

Embodiments herein relate to a first network node, a second network node, and methods therein. In some aspects, they relate to providing status information associated with a third network node in a wireless communications network.

### BACKGROUND

In a typical wireless communication network, wireless devices, also known as wireless communication devices, mobile stations, stations (STA) and/or User Equipments (UE)s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHz. Bands in this millimetre wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### Mobility Load Balance in Evolved Universal Mobile Telecommunications System Terrestrial Radio Access (E-UTRAN) Systems

In mobile networks, the load of a radio access node is constantly measured so that when it gets above a pre-configure threshold, procedures can be triggered so that part of this load is transferred to either a neighbor cell of the same radio access technology (RAT) or another RAT or frequency. The set of procedures to support this transfer is called mobility load balance (MLB). Currently, 3GPP specifies the following components for the MLB solution:
Load reporting
Load balancing action based on handovers (HO)s.
Adapting HO/cell reselection (CR) configuration so that the load remains balanced.

In E-UTRAN systems, the load reporting function is executed by exchanging cell specific load information between neighbor enhanced NodeBs (eNBs) over the X2 (intra-LTE scenario) or S1 (inter-RAT scenario) interfaces. In the case of intra-LTE load balance, the source eNB (i.e., eNB1) may initiate a resource status reporting procedure by transmitting a RESOURCE STATUS REQUEST message to potential target eNBs (e.g., eNB2) at any point in time, for example when the load in its cells exceeds a certain threshold. Load information that the source eNB can request the target eNB to report may comprise one or more types of information on a per cell level, including:
Composite available capacity (per cell)
Radio resource status utilization in downlink and/or uplink (per cell)
Transport Network Layer (TNL) load indicator
Hardware load indicator

If the target eNB can provide all or part of the information requested by the source eNB, the target eNB transmits a RESOURCE STATUS RESPONSE message to the source eNB to acknowledge (in full or only in part) the successful initialization of the resource status reporting, as illustrated in FIG. 1. In other words, FIG. 1 illustrates a Resource Status Reporting Initiation, successful operation in E-UTRAN systems cf. 3GPP TS 36.423.

If none of the requested measurements can be initiated, eNB2 shall send a RESOURCE STATUS FAILURE message. The Cause IE shall be set to an appropriate value e.g. “Measurement Temporarily not Available” or “Measurement not Supported For The Object” for each requested measurement object. The eNB may use the Complete Failure Cause Information IE to enhance the failure cause information per measurement in the RESOURCE STATUS FAILURE message, as illustrated in FIG. 2. In other words, FIG. 2 a illustrates a Resource Status Reporting Initiation, unsuccessful operation in E-UTRAN systems cf. 3GPP TS 36.423.

Upon a successful configuration of resource status reporting from target to source, the target eNB can respond (periodically or not) with a RESOURCE STATUS UPDATE message containing the required load information about its cells. The message exchange is highlighted in FIG. 3. In other words, FIG. 3 a illustrates Resource Status Reporting, successful operation with transmission of the requested measurements with RESOURCE STATUS UPDATE message in E-UTRAN systems, cf. 3GPP TS 36.423.

### Motility Load Balancing in NG-RAN

The current NG RAN architecture is described in 3GPP TS 38.401 and illustrated in FIG. 4: The NG architecture can be further described as follows:
The NG-RAN consists of a set of gNBs connected to the 5GC through the NG.
A gNB can support Frequency Division Duplex (FDD) mode, Time Division Duplex (TDD) mode or dual mode operation.
gNBs can be interconnected through the Xn.
A gNB may consist of a gNB Central Unit (gNB-CU; CU) and one or more gNB Distributed Unit (gNB-DUs; DUs).
A gNB-CU and a gNB-DU are connected via F1 logical interface.
One gNB-DU is connected to only one gNB-CU.

The architecture in FIG. 4 can be expanded by spitting the gNB-CU into two entities. One gNB-CU-UP, which serves the user plane and hosts the Packet Data Convergence Protocol (PDCP) protocol and one gNB-CU-CP, which serves the control plane and hosts the PDCP and Radio Resource Control (RRC) protocol. The interface connecting gNB-CU-CP and gNB-CU-UP is named E1.

NG, Xn, E1 and F1 are logical interfaces. For NG-RAN, the NG and Xn-C interfaces for a gNB consisting of a gNB-CU and gNB-DUs, terminate in the gNB-CU. For E-UTRAN New Radio-Dual Connectivity (EN-DC), the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The NG-RAN is layered into a Radio Network Layer (RNL) and a Transport Network Layer (TNL). The NG-RAN architecture, i.e. the NG-RAN logical nodes and interfaces between them, is defined as part of the RNL. For each NG-RAN interface (NG, Xn, E1, F1) the related TNL protocol and the functionality are specified. The TNL provides services for user plane transport and signaling transport. In NG-Flex configuration, each gNB is connected to all Access and Mobility management Functions (AMFs) within an AMF Region. The AMF Region is defined in 3GPP TS 23.501.

A similar architecture can be foreseen in a 4G network too, either as future 3GPP development or a proprietary product development. The concept of CU, DU and F1 interface can be applied to a 4G eNB also.

The NG-RAN system currently extends the E-UTRAN resource status reporting procedure to support the exchange of load information between two NG-RAN nodes (i.e., intra NG-RAN operations), between an NG-RAN node and an en-eNB node (for EN-DC operation), as well as between and NG-RAN node and an E-UTRAN node (for inter-system operation).

In this case, the source NG-RAN node (e.g., NG-RAN node1) may initiate a resource status reporting procedure by transmitting a RESOURCE STATUS REQUEST message to potential target source NG-RAN nodes (e.g., NG-RAN node2) at any point in time, as illustrated in FIG. 5. However, NG RAN system currently support the exchange of load information on a finer granularity compared to E-UTRAN systems, including load information per Synchronization Signal Block (SSB) beam coverage area and per network slice. For example, load information that the source NG-RAN node can request the target NG-RAN node to report may comprise one or more of the following information:
Composite available capacity, e.g. per cell, per SSB beam coverage area,
Slice available capacity, e.g. Network Slice Selection Assistance Information (S-NSSAI),
Radio resource status utilization in downlink and/or uplink, e.g. per cell, per SSB beam coverage area,
TNL load indicator,
Hardware load indicator,
Number of Active UEs,
RRC connections.

If the target NG_RAN node can provide all or part of the information requested by the source NG-RAN node, the target NG-RAN node transmits a RESOURCE STATUS RESPONSE message to the source NG-RAN node to acknowledge (in full or only in part) the successful initialization of the resource status reporting, as illustrated in FIG. 5. In other words, FIG. 5 a illustrates Resource Status Reporting Initiation, successful operation in NG-RAN systems, cf. 3GPP TS 38.423.

If any of the requested measurements cannot be initiated, NG-RAN node2 shall send the RESOURCE STATUS FAILURE message to NG-RAN node1 with an appropriate cause value. FIG. 6 illustrates a Resource Status Reporting Initiation, unsuccessful operation in NG-RAN systems, cf. 3GPP TS 38.423.

Upon a successful initialization of the resource status reporting procedure, the NG-RAN node2 shall report the results of the admitted measurements in RESOURCE STATUS UPDATE message. The admitted measurements are the measurements that were successfully initiated during the preceding Resource Status Reporting Initiation procedure, as illustrated in FIG. 7. In other words, FIG. 7 illustrates a Resource Status Reporting, successful operation with transmission of the requested measurements with RESOURCE STATUS UPDATE message in E-UTRAN systems, cf. 3GPP TS 36.423.

To support mobility load balancing in split RAN architecture in NG-RAN systems, the resource status reporting procedure is defined over three main communication interfaces: Xn, F1 and E1. Additionally, resource status reporting is enabled also the X2 interface to support mobility load balancing in case of EN-DC operations and inter-system load balancing (currently being finalized).

### Recent Evolvements of Mobility Load Balancing in E-UTRAN and NG-RAN Systems

To continue improving the operations of E-UTRAN and NG-RAN systems, proposals have been discussed in the 3GPP RAN3 standardization body to enable a target NG-RAN node or a target E-UTRAN node to report to the requesting node, not only its own load information, but also load information associated with a third network node, which could represent, for instance, the candidate/target node for either resource aggregation or EN-DC operations e.g., a candidate Primary Secondary Cell Group Cell (PSCell). The principle behind this approach is to enable the source node (in an NG-RAN system or in an E-UTRAN system) to make better decisions about offloading parts of its load to the target node based not only on the availability or usage of resources reported by the target node, but also on other resources that could be accessible the target node. Examples of such solutions are described, for instance, in 3GPP RAN3 contributions R3-213510 e R3-213511.

### SUMMARY

As a part of developing embodiments herein the inventors identified a problem which first will be discussed.

A problem arises when trying to improve mobility load balancing operations in wireless communications networks such as in NG-RAN and/or E-UTRAN systems. This problem relates to excessive signaling which typically appears as when a second network node forwards load information associated with its neighbor network nodes, e.g. a third network node, to a first network node, e.g. forwarded within a RESOURCE STATUS UPDATE message of a status reporting procedure. The additional signaling overhead due to forwarding the load information may in many cases degrade the system performance, e.g. as it causes a lot of extra traffic in the network.

Another problem with forwarding load information concerning neighboring nodes of a second network node to a first network node is that the forwarded load information may not be useful to the first network node nor necessary, and thus only causes extra traffic in the network. This may e.g. be when the forwarded load information relates to network nodes or cells which may not be used since the do not have sufficient resources, e.g. to provide a good service to UEs.

An object of embodiments herein is to provide an efficient way of handling load balancing to improve the performance of wireless communications networks. According to an aspect of embodiments herein, the object is achieved by a method performed by a first network node for requesting a second network node to provide status information associated with a third network node in a wireless communications network. The first network node requests the second network node to provide status information by transmitting a first request message to the second network node. The first request message is indicative of one or more conditions for triggering the second network node to provide status information associated with the third network node, when at least one of the one or more conditions is fulfilled. The first network node receives a message from the second network node. The message is indicative of any one out of:
A successful or partially successful initialization of a conditional forwarding configuration procedure; or
a status information associated with the third network node, based on that the at least one of the one or more conditions is fulfilled; or
an unsuccessful or failure to initialize the conditional forwarding configuration procedure.

According to an aspect of embodiments herein, the object is achieved by a method performed by a second network node for providing status information associated with a third network node to a first network node in a wireless communications network. The second network node receives a first request message from the first network node. The first request message is indicative of one or more conditions for triggering the second network node to provide status information associated with the third network node, when at least one of the one or more conditions is fulfilled. The second network node transmits a message to the first network node. The messages is indicative of any one out of:
A successful or partially successful initialization of a conditional forwarding configuration procedure, or
a status information associated with the third network node based on that the at least one of the one or more conditions is fulfilled, or
an unsuccessful or failure to initialize the conditional forwarding configuration procedure.

According to an aspect of embodiments herein, the object is achieved by a first network node configured to request a second network node to provide status information associated with a third network node in a wireless communications network. The first network node is further configured to:
Request the second network node to provide status information by transmitting a first request message to the second network node, wherein the first request message is adapted to be indicative of one or more conditions for triggering the second network node to provide status information associated with the third network node, when at least one of the one or more conditions is fulfilled,
receive message from the second network node indicative of any one out of:
   A successful or partially successful initialization of a conditional forwarding configuration procedure, or
   a status information associated with the third network node, based on that the at least one of the one or more conditions is fulfilled, or
   an unsuccessful or failure to initialize the conditional forwarding configuration procedure.

According to an aspect of embodiments herein, the object is achieved by a second network node configured to provide status information associated with a third network node to a first network node in a wireless communications network. The second network node is further configured to:
Receive a first request message from the first network node, wherein the first request message is indicative of one or more conditions for triggering the second network node to provide status information associated with the third network node, when at least one of the one or more conditions is fulfilled,
transmit a message to the first network node indicative of any one out of:
   A successful or partially successful initialization of a conditional forwarding configuration procedure, or
   a status information associated with the third network node based on that the at least one of the one or more conditions is fulfilled, or
   an unsuccessful or failure to initialize the conditional forwarding configuration procedure.

As the request message indicates the one or more conditions for triggering the second network node to provide status information associated with the third network node, an improved efficiency of handling load balancing is achieved. This is since this allows load balancing to be handled based on status information of the third network node. Furthermore, the status information is only provided when the one or more conditions are fulfilled, thus requiring reduced signalling.

### BRIEF DESCRIPTION OF THE DRAWINGS

Examples of embodiments herein are described in more detail with reference to attached drawings in which:

FIG. 1 is a sequence diagram illustrating prior art.

FIG. 2 is a sequence diagram illustrating prior art.

FIG. 3 is a sequence diagram illustrating prior art.

FIG. 4 is a schematic block diagram illustrating prior art.

FIG. 5 is a sequence diagram illustrating prior art.

FIG. 6 is a sequence diagram illustrating prior art.

FIG. 7 is a sequence diagram illustrating prior art.

FIG. 8 is a schematic block diagram illustrating embodiments of a wireless communications network.

FIG. 9 is a flowchart depicting an embodiment of a method in a first network node.

FIG. 10 is a flowchart depicting an embodiment of a method in a first network node.

FIG. 11 is a sequence diagram depicting an embodiment herein.

FIG. 12 is a sequence diagram depicting an embodiment herein.

FIG. 13 is a combined block and sequence diagram depicting an embodiment herein.

FIG. 14 is a sequence diagram depicting an embodiment herein.

FIG. 15 is a sequence diagram depicting an embodiment herein.

FIG. 16 is a sequence diagram depicting an embodiment herein.

FIG. 17 is a sequence diagram depicting an embodiment herein.

FIG. 18 a and b are schematic block diagrams illustrating embodiments of a wireless device.

FIG. 19 a and b are schematic block diagrams illustrating embodiments of a network node.

FIG. 20 schematically illustrates a telecommunication network connected via an intermediate network to a host computer.

FIG. 21 is a generalized block diagram of a host computer communicating via a base station with a user equipment over a partially wireless connection.

FIGS. 22-25 are flowcharts illustrating methods implemented in a communication system including a host computer, a base station and a user equipment.

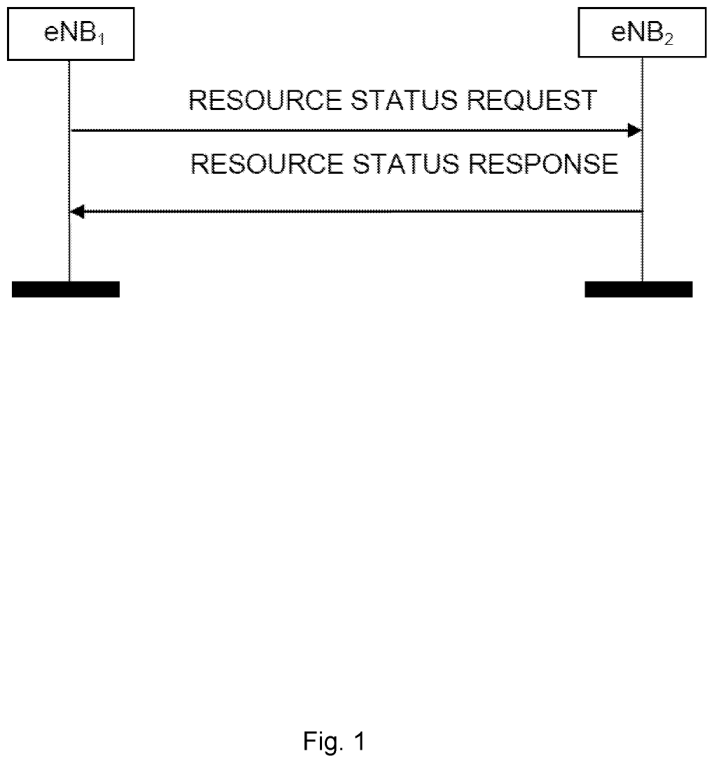

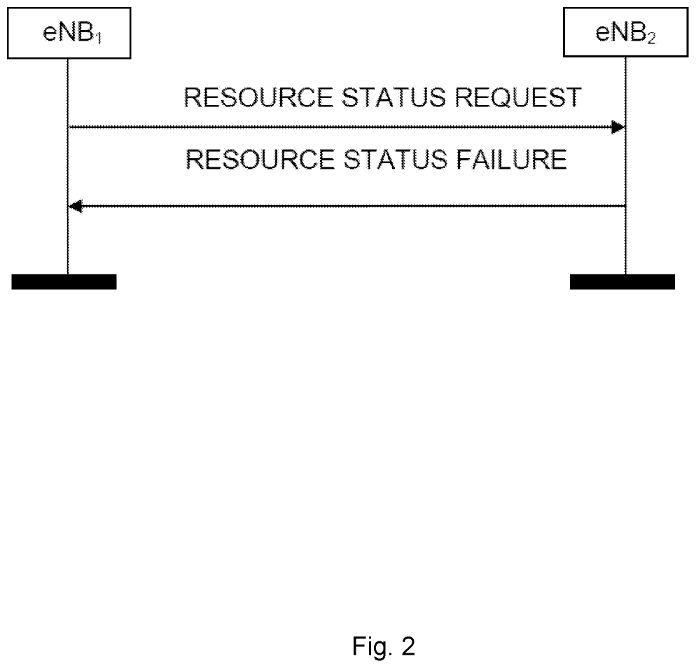

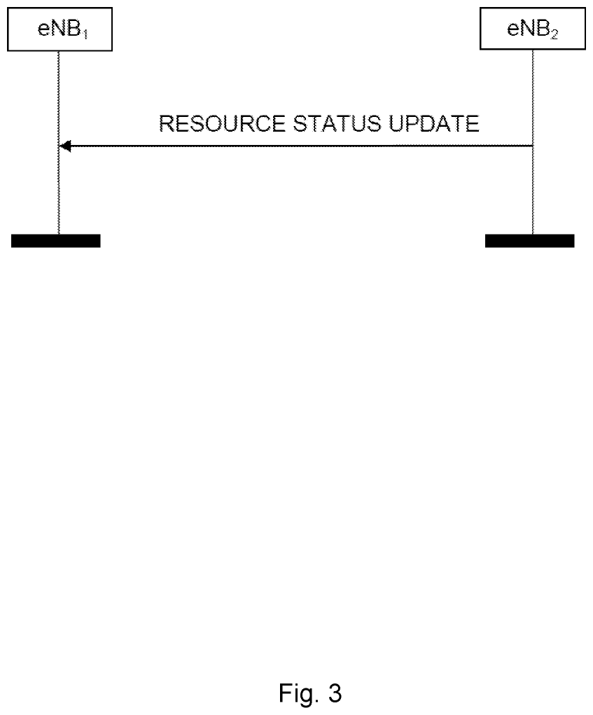

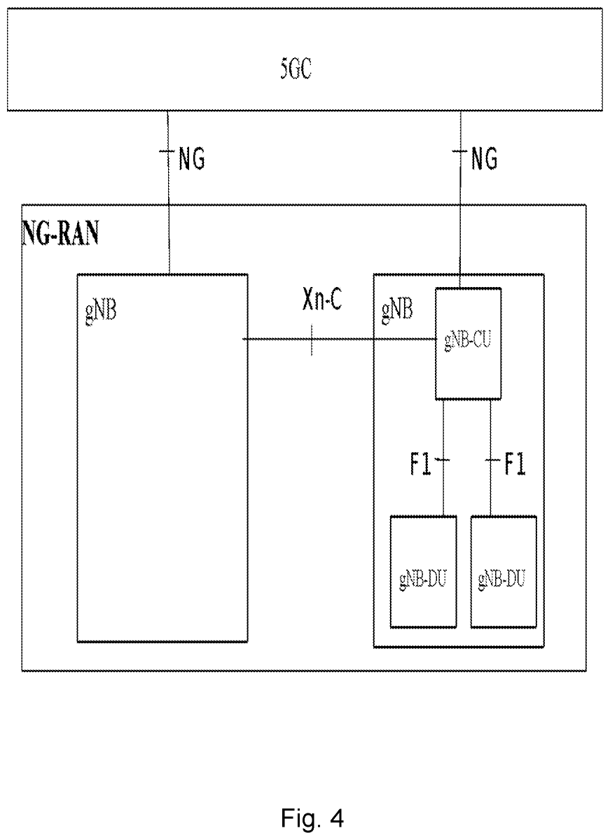

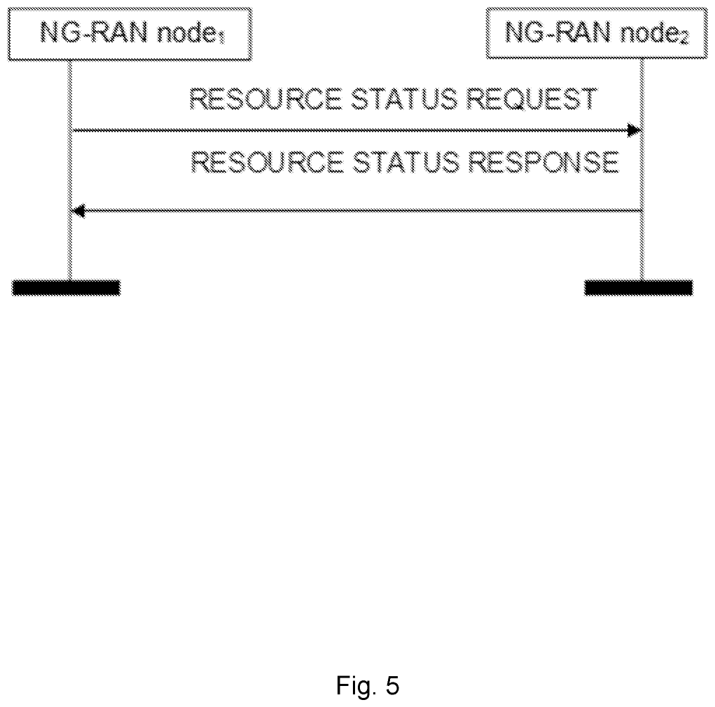

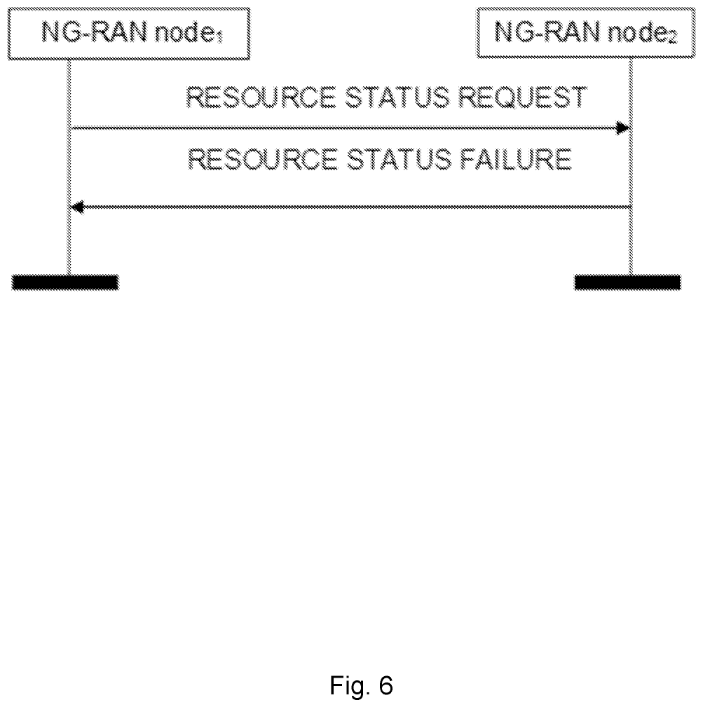

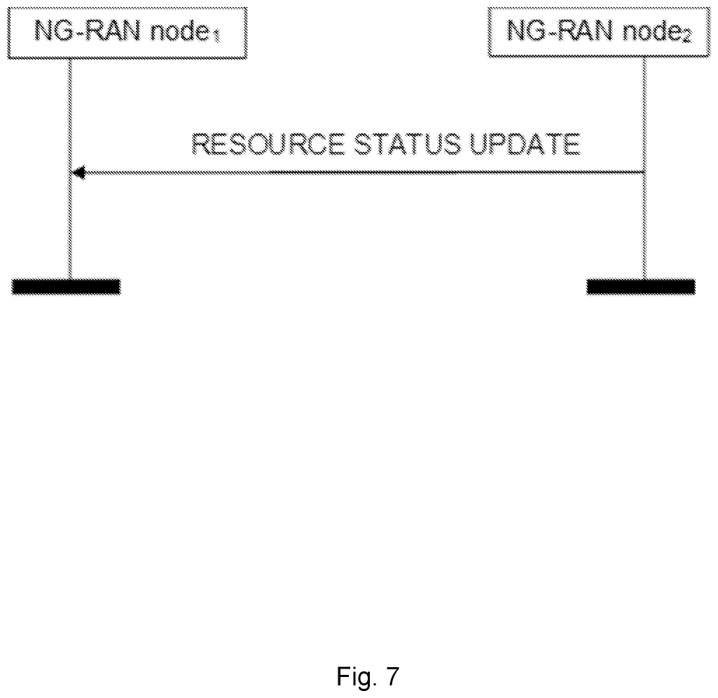

### DETAILED DESCRIPTION

Example of embodiments herein e.g. provide a method for a first network node to request and receive load information from a second network node. The load information is associated with a third network node. The load information is in some embodiments received only when the second network node has verified that one or more conditions are fulfilled for forwarding the requested load information. The conditions for triggering the reporting of the requested load information may e.g. be associated with one or more operations of the third network node and/or of the second network node which will be explained further by the examples and embodiments below.

An advantage of embodiments herein is that transmission, e.g. forwarding, of status information, e.g. load information, between network nodes may be performed only when the load information is necessary, e.g. for performing load balancing decisions.

In this way, embodiments herein avoid unnecessary signaling among network nodes and thus improves energy savings and/or reduces network traffic in a wireless communications network without compromising performance, e.g. network throughput, spectral efficiency and/or user satisfaction.

Another advantage of the embodiments herein is that an efficient load information exchange e.g. comprising only for relevant load information to be exchanged across multiple network nodes, when necessary, improves the quality of the information received at the first network node for controlling and optimizing its operations, e.g. mobility load balancing operations.

Another advantage of embodiments herein is that the first network node is enabled to determine whether there is an advantage in triggering a mobility action, e.g. a handover to the third network node and/or to trigger a multi-radio connectivity related procedure with the third network node for at least one UE served by the first network node.

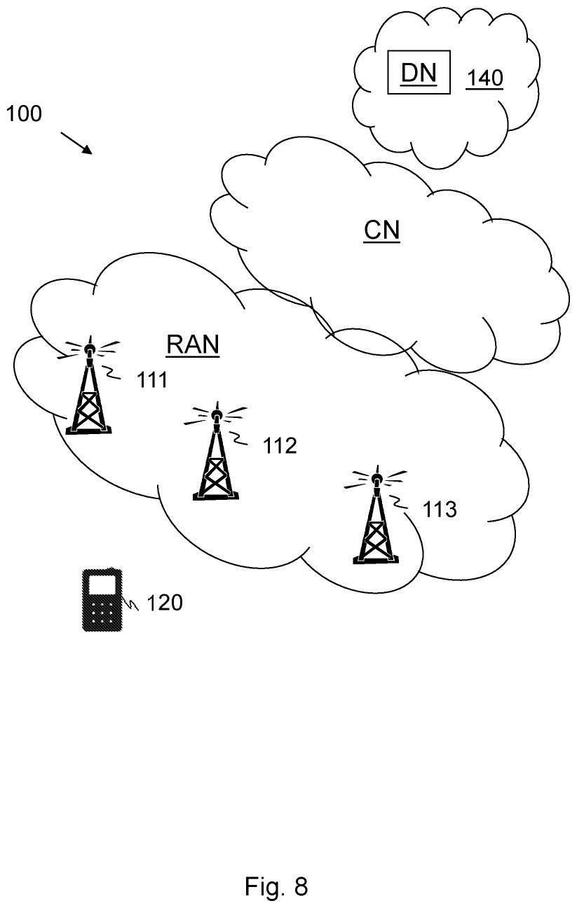

FIG. 8 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, LTE, LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a first network node 111, a second network node 112, and a third network node 113, operate in the wireless communications network 100. The first network node 111, the second network node 112, and/or the third network node 113, may each respectively e.g. provide a number of cells and may use these cells for communicating with e.g. a UE 120. The first network node 111, the second network node 112, and/or the third network node 113, may each respectively e.g., be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the respective network node e.g. depending on the radio access technology and terminology used.

UEs operate in the wireless communications network 100, such as a UE 120. The UE 120 may e.g. be configured to communicate using a cell provided by any one of the first network node 111, the second network node 112, and/or the third network node 113. The UE 120 may e.g. be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g. the first network node 111, the second network node 112, and/or the third network node 113, e.g., via one or more Access Networks (AN), e.g. RAN, to one or more core networks (CN). It should be understood by the skilled in the art that the term UE as used herein relates to a non-limiting term which means any UE, terminal, wireless communication terminal, wireless terminal, user equipment, Device to Device (D2D) terminal, or node e.g. smart phone, laptop, mobile phone, sensor, relay, mobile tablets or even a small base station communicating within a cell.

Methods herein may in some aspects be performed by the first network node 111 and/or the second network node 112. As an alternative, a Distributed Node (DN) and functionality, e.g. comprised in a cloud 140 as shown in FIG. 8, may be used for performing or partly performing the methods.

### Terminology Disclaimers

In the context of embodiments herein, the term status information and/or load information, is broadly used to indicate many different types of metrics and/or values. In other words, status information and load information may be used interchangeably herein. Load information and/or status information may in embodiments herein may e.g. mean and/or relate to any one or more out of capacity information, load information, resource status utilization information, hardware utilization, associated with a network node and/or to a radio cell of a network node and/or to a partition/portion of a radio cells of a network node, e.g. as defined, for instance, by a coverage area of a downlink reference signal beam. Non limiting examples of load information may be, e.g., one or more load and/or capacity metrics defined by the 3GPP LTE and NG-RAN systems for each respective resource status reporting procedures.

Whenever the term gNB or network node is used, as well as gNB-CU and gNB-DU, the term may refer to any network node or unit, e.g. CU or DU suitable for performing embodiments herein, such as e.g. the first network node 111, the second network node 112 and/or the third network node 113. Likewise, when mentioning the F1 interface or any other suitable interface, this may mean the interface, e.g. the F1 interface, e.g. as per 3GPP standardization, but may also mean any proprietary interface between eNB-DU and eNB-CU suitable for performing embodiments herein.

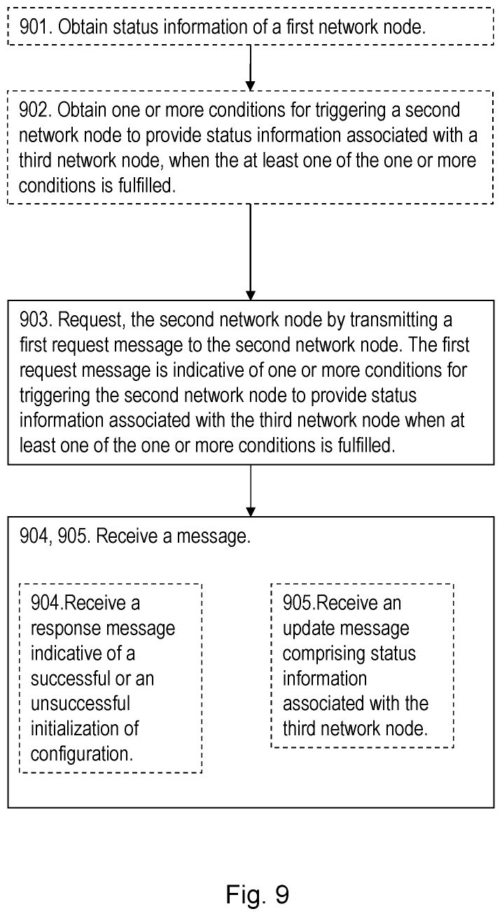

FIG. 9 shows an example method performed by the first network node 111 for configuring, also referred to as requesting, the second network node 112 to provide status information, e.g. load information, associated with the third network node 113 in the wireless communications network 100. The method may comprise any one or more out of the actions below. The following actions may be performed in any suitable order.

### Action 901

In some embodiments, the first network node 111 may obtain status information, e.g. load information, of the first network node 111. The obtained status information of the first network node 111 may be any information of the first network node 111 which may be used for determining which type of status information, e.g. load information, associated with the third network node 113, that may be useful or necessary for the first network node 111, e.g. for performing improved mobility operations.

### Action 902

In some embodiments, the first network node 111, obtains, e.g. determines, one or more conditions for triggering the second network node 112 to provide status information, e.g. load information, associated with the third network node 113, e.g., only, when at least one of the one or more conditions is fulfilled. The obtained one or more conditions may in some embodiments be predetermined.

In some embodiments, each respective condition out of the one or more conditions relates to a condition to be fulfilled by the third network node 113. Any one or more out of the one or more conditions may relate to any one or more out of:
one or more cell types, e.g. Primary Secondary Cell Group Cell, PSCell,
one or more network node types,
one or more identifiers, e.g. index/indices, e.g. of a beam, e.g. SSB beam, e.g. of a cell, e.g. of a network node, e.g. of a coverage area, e.g. of a network slice, e.g. of a group of network nodes, e.g. of a group of SSB beams,
one or more identifier of one or more coverage areas,
measurements and/or predictions of any one or more out of load information, coverage information, and/or traffic load information,
resource status utilization and/or resource status availability,
e.g. measurements and/or predictions of, hardware load and/or hardware capacity,
Guaranteed Bit Rate, GBR, and/or non-GBR Physical Resource Block usage in Uplink and/or in Downlink e.g. of at least one cell,
Physical Downlink Control Channel, PDCCH, Control Channel Element, CCE scheduling in Uplink and/or in Downlink of at least one cell,
UE status, e.g. activity and/or capability of one or more UEs, and/or a number/quantity of UEs, e.g. within a cell,
any one or more out of resource status utilization, resource status availability, types or number of user devices, hardware load, and/or hardware capacity.

In other words, the one or more conditions may relate to a wide range of parameters for when to trigger the second network node 112 to provide status information, e.g. load information, associated with the third network node 113.

In some embodiments, any one or more conditions out of the one or more conditions may be used for explicit indication of the third network node 113 and/or related beams, cells, or identifiers, e.g. of the third network node 113. In these embodiments, any one or more out of the following conditions out of the one or more conditions, e.g. as listed above, and/or any other suitable conditions, may be used to explicitly indicate the third network node 113 and/or to be provided with/in messages explicitly indicating the third network node 113:
one or more cell types, e.g. Primary Secondary Cell Group Cell, PSCell, e.g. of the third network node 113,
one or more network node types e.g. of the third network node 113, and
one or more identifiers, e.g. index/indices, e.g. of a beam, e.g. SSB beam, e.g. of a cell, e.g. of a network node, e.g. of a coverage area, e.g. of a network slice, e.g. of a group of network nodes, e.g. of a group of SSB beams, e.g. of the third network node 113.

In some embodiments, the one or more conditions may relate to the third network node 113 only. In some embodiments, the one or more conditions may relate to both of the third network node 113 and the second network node 112.

In some embodiments, the one or more conditions comprises at least one filtering condition, e.g. wherein the at least one filtering condition indicates, e.g. to the second network node 112, at least some status information, e.g. load information, not to be transmitted e.g. forwarded, to the first network node 111. In other words, the filtering condition may relate to status information, e.g. load information, which the first network node 111 does not want to receive.

In some embodiments, the first network node 111 obtains, e.g. determines, the one or more conditions for triggering the second network node 112 to provide status information, e.g. load information, associated with the third network node 113, e.g., only, when the at least one of the one or more conditions is fulfilled, based on the obtained status information, e.g. load information, of the first network node 111. In other words, the first network node 111 may first determine what type of status information, e.g. load information, it needs, e.g. to perform improved operations, e.g. mobility operations, and may then obtain the one or more conditions for triggering the second network node 112 to provide such status information, e.g. load information.

### Action 903

In some embodiments, the first network node 111 configures, also referred to as requests, the second network node 112 e.g. by transmitting a first request message to the second network node 112. The first request message is indicative of the one or more conditions for triggering the second network node 112 to provide status information, e.g. load information, associated with the third network node 113, when the at least one of the one or more conditions is fulfilled. In some embodiments, only when the at least one of the one or more conditions is fulfilled. In this way, the second network node 112 will be enabled to provide status information, e.g. load information, associated with the third network node 113 e.g., only, when needed by the first network node 111.

In some embodiments, the first request message may indicate which status information, e.g. load information, to be transmitted, e.g. forwarded, to the first network node 111.

In some embodiments, the first request message may comprise an implicit or explicit indication of the third network node 113. In some embodiments, the first request message may indicate the identity of the third network node 113. In some other embodiments, the identity of the third network node 113 is not indicated.

In some embodiments, any one or more out of the one or more conditions may e.g. explicitly mention and/or explicitly relate to the third network node 113. For example, identifiers of the one or more conditions may be related to identifiers of the third network node 113 e.g. network node identifiers and/or cells, beams, etc., e.g. which may e.g. be provided by the third network node 113.

In some embodiments, the first request message indicates to the second network node 112 any one or more out of:
an identifier of at least the third network node 113 for which conditions are provided for reporting status information to the first network node 111,
an identifier of at least a radio cell associated with at least the third network node 113 for which conditions are provided for reporting status information to the first network node 111,
an identifier of the coverage area of at least one Synchronization Signal Block, SSB, beam of a group of SSB beams associated with at least the third network node 113 for which conditions are provided for reporting status information to the first network node 111,
an identifier of at least a network slice or a group of network slices associated with at least the third network node 113 for which conditions are provided for reporting status information to the first network node 111, and
a combination thereof.

In some embodiments, the one or more conditions triggers the second network node 112 to provide the status information associated with the third network node 113, only when the at least one of the one or more conditions is fulfilled.

In some embodiments, the one or more conditions are associated with operations of the third network node 113 and the second network node 112, or associated with the third network node 113 only.

In some embodiments, the one or more conditions are provided by the first network node 111 to the second network node 112 for triggering the reporting of status information associated with the third network node 113 and is based on any one or more out of:
one or more measurements or predictions of capacity or load information associated with the third network node 113 and/or the second network node 112,
one or more measurements and/or predictions of coverage information associated with the third network node 113 and/or the second network node 112,
one or more measurements or predictions of one or more traffic type or traffic load information associated with the third network node 113 and/or the second network node 112, and
a combination thereof.

In some embodiments, the one or more conditions are based on one or more measurements or predictions of at least one capacity metric at the third network node 113, wherein the at least one capacity metric are any of a Composite Available Capacity (CAC), a capacity value, a transport network capacity metric, or a combination thereof, and wherein the one or more conditions relating to available capacity is expressed per cell of the third network node 113, per SSB beam or group of SSB beam coverage area at the third network node 113, per network slice or group of network slices, or combinations thereof.

In some embodiments, the one or more conditions are based on one or more measurements or predictions of resource status utilization or resource status availability at the third network node 113, and wherein the one or more conditions relating to resource status utilization or resource status availability is expressed per cell of the third network node 113, per SSB beam or group of SSB beam coverage area at the third network node 113, per network slice or group of network slices, or combinations thereof.

In some embodiments, the one or more conditions are based on measurements or predictions of one or more types of number of user devices present in a coverage area of radio cells, per coverage area of individual SSB beams or groups thereof, per network slice or group of network slices of the third network node 113, or a combination thereof.

In some embodiments, the one or more conditions comprises conditions relating to a combination of conditions at the third network node 113, the combination of conditions relating to metrics of any one or more out of: capacity, resource status utilization, resource status availability, types or number of user devices, hardware load, hardware capacity.

In some embodiments, the at least one of the one or more conditions are based on measurements or predictions of hardware load or hardware capacity at the third network node 113.

The first request message may be transmitted from the first network node 111, to the second network node 112, e.g., as part of requesting an initialization configuration procedure also referred to as a conditional forwarding configuration procedure.

### Actions 904, 905

The first network node 111 receives 904, 905 a message from the second network node 112. The message may e.g. be a first response message and/or an update message. The message is indicative of any one out of:
e.g. in the first response message, a successful or partially successful initialization of a configuration procedure also referred to as a conditional forwarding configuration procedure, e.g. based on that the at least one of the one or more conditions is fulfilled, or
e.g. in the update message, a status information, e.g. load information, associated with the third network node 113 based on that the at least one of the one or more conditions is fulfilled, or
e.g. in the first response message, an unsuccessful or failure to initialize the configuration procedure, also referred to as a conditional forwarding configuration procedure, e.g. based on that the at least one of the one or more conditions is not fulfilled.

In other words, the first network node 111 may be informed of whether or not the configuration of the second network node 112 to provide the status information, e.g. load information, associated the third network node 113, e.g. based on the one or more conditions, is successfully initialized or not. Furthermore, when the at least one condition of the one or more conditions is fulfilled, the first network node 111 may receive the status information, e.g. load information, associated with the third network node 113 and may then perform improved operations, e.g. mobility operations, based on the received status information, e.g. load information.

As a further clarification, in some embodiments, the second network 112, transmits the message, e.g., the first response message to the first network node 111, as part of a reply for informing of whether or not the request to initialize the configuration procedure also referred to as a e.g. conditional forwarding configuration succeeded or failed. In some other embodiments, the message comprises the status information as an update message.

In some embodiments, the status information associated with the third network node 113 comprises any one or more out of: capacity information, load information, resource status utilization information, and hardware utilization associated with the third network node 112.

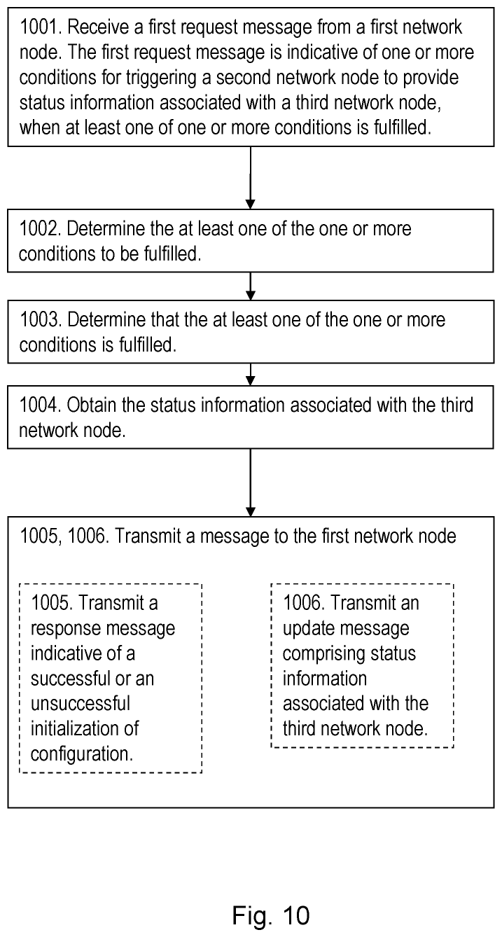

FIG. 10 shows an example method performed by the second network node 112, e.g. for configuring, e.g. such as the first network node 111 requesting, the second network node 112 to provide status information, e.g. load information, associated with the third network node 113 to the first network node 111, in the wireless communications network 100. The method may comprise any one or more out of the actions below. The following actions may be performed in any suitable order.

### Action 1001

In some embodiments, the second network node 112 receives a first request message from the first network node 111. The first request message is indicative of one or more conditions for triggering the second network node 112 to provide status information, e.g. load information, associated with the third network node 113, when at least one of the one or more conditions is fulfilled. In some embodiments, only when the at least one of the one or more conditions is fulfilled. In this way, the second network node 112 is enabled to provide status information, e.g. load information, associated with the third network node 113 only when needed by the first network node 111.

In some embodiments, the first request message may indicate which status information, e.g. load information, to transmit, e.g. forward, to the first network node 111.

In some embodiments, the first request message may in some embodiments indicate the identity of the third network node 112. In some other embodiments, the identity of the third network node 113 is not indicated.

In some embodiments, each respective condition out of the one or more conditions relates to a condition to be fulfilled by the third network node 113. Any one or more out of the one or more conditions may relate to any one or more out of:
one or more cell types, e.g. Primary Secondary Cell Group Cell, PSCell,
one or more network node types,
one or more identifiers, e.g. index/indices, e.g. of a beam, e.g. SSB beam, e.g. of a cell, e.g. of a network node, e.g. of a coverage area, e.g. of a network slice, e.g. of a group of network nodes, e.g. of a group of SSB beams,
one or more identifier of one or more coverage areas,
measurements and/or predictions of any one or more out of load information, coverage information, and/or traffic load information,
resource status utilization and/or resource status availability,
e.g. measurements and/or predictions of, hardware load and/or hardware capacity,
Guaranteed Bit Rate, GBR, and/or non-GBR Physical Resource Block usage in Uplink and/or in Downlink e.g. of at least one cell,
Physical Downlink Control Channel, PDCCH, Control Channel Element, CCE scheduling in Uplink and/or in Downlink of at least one cell,
UE status, e.g. activity and/or capability of one or more UEs, and/or a number/quantity of UEs, e.g. within a cell,
any one or more out of resource status utilization, resource status availability, types or number of user devices, hardware load, and/or hardware capacity.

In other words, the one or more conditions may relate to a wide range of parameters for when to trigger the second network node 112 to provide status information, e.g. load information, associated with the third network node 113.

In some embodiments, the one or more conditions may relate to the third network node 113 only. In some embodiments, the one or more conditions may relate to both of the third network node 113 and the second network node 112.

In some embodiments, the one or more conditions comprises at least one filtering condition, e.g. wherein the at least one filtering condition indicates, e.g. to the second network node 112, at least some status information, e.g. load information, not to be transmitted e.g. forwarded, to the first network node 111.

In some embodiments, the first request message indicates to the second network node 112 any one or more out of:
an identifier of at least the third network node 113 for which conditions are provided for reporting status information to the first network node 111,
an identifier of at least a radio cell associated with at least the third network node 113 for which conditions are provided for reporting status information to the first network node 111,
an identifier of the coverage area of at least one Synchronization Signal Block, SSB, beam of a group of SSB beams associated with at least the third network node 113 for which conditions are provided for reporting status information to the first network node 111,
an identifier of at least a network slice or a group of network slices associated with at least the third network node 113 for which conditions are provided for reporting status information to the first network node 111, and
a combination thereof.

The first request message may be transmitted from the first network node 111, to the second network node 112, e.g., as part of requesting an initialization configuration procedure also referred to as a conditional forwarding configuration procedure.

### Action 1002

In some embodiments, the second network node 112 e.g. optionally determines the at least one of the one or more conditions to be fulfilled, e.g. for providing status information, e.g. load information, associated with the third network node 113, to the first network node 111. For example, the second network node 112 may select the at least one condition to of the one or more conditions to be fulfilled from the one or more conditions.

In some embodiments, the one or more conditions triggers the second network node 112 to provide status information associated with the third network node 113, only when the at least one of the one or more conditions is fulfilled.

In some embodiments, the one or more conditions are associated with operations of the third network node 113 and the second network node 112, or associated with the third network node 113 only.

In some embodiments, the one or more conditions are provided by the first network node 111 to the second network node 112 for triggering the reporting of status information associated with the third network node 113 and is based on any one or more out of:
one or more measurements or predictions of capacity or status information associated with the third network node 113 and/or the second network node 112,
one or more measurements and/or predictions of coverage information associated with the third network node 113 and/or the second network node 112,
one or more measurements or predictions of one or more traffic type or traffic load information associated with the third network node 113 and/or the second network node 112, and
a combination thereof.

In some embodiments, the one or more conditions are based on one or more measurements or predictions of at least one capacity metric at the third network node 113, wherein the at least one capacity metric are any of a Composite Available Capacity (CAC), a capacity value, a transport network capacity metric, or a combination thereof, and wherein the one or more conditions relating to available capacity is expressed per cell of the third network node 113, per SSB beam or group of SSB beam coverage area at the third network node 113, per network slice or group of network slices, or combinations thereof.

In some embodiments, the one or more conditions are based on one or more measurements or predictions of resource status utilization or resource status availability at the third network node 113, and wherein the one or more conditions relating to resource status utilization or resource status availability is expressed per cell of the third network node 113, per SSB beam or group of SSB beam coverage area at the third network node 113, per network slice or group of network slices, or combinations thereof.

In some embodiments, the one or more conditions are based on measurements or predictions of one or more types of number of user devices present in a coverage area of radio cells, per coverage area of individual SSB beams or groups thereof, per network slice or group of network slices of the third network node 113, or a combination thereof.

In some embodiments, the one or more conditions comprises conditions relating to a combination of conditions at the third network node 113, the combination of conditions relating to metrics of any one or more out of: capacity, resource status utilization, resource status availability, types or number of user devices, hardware load, hardware capacity.

In some embodiments, the at least one of the one or more conditions are based on measurements or predictions of hardware load or hardware capacity at the third network node 113.

### Action 1003

In some embodiments, the second network node 112 determines, e.g., verifies, that the at least one of the one or more conditions is fulfilled. This may be performed by any suitable means, e.g. by measuring some data, or receiving data indicating the at least one of the one or more conditions is fulfilled.

### Action 1004

In some embodiments, the second network node 112 obtains the status information, e.g. load information, associated with the third network node 113, from the third network node 113. The second network node 112 may obtain the status information, e.g. load information, by requesting and receiving the status information from the third network node 113, e.g. triggered by and/or based on the first request message.

In some embodiments, the status information associated with the third network node 113 comprises any one or more out of: capacity information, load information, resource status utilization information, and hardware utilization associated with the third network node 112.

### Actions 1005, 1006

The second network node 112, transmits a message to the first network node 111. The message may be a first response message and/or an update message. The message is indicative of any one out of:
e.g. in the first response message, a successful or partially successful initialization of a configuration procedure also referred to as a conditional forwarding configuration procedure, e.g. based on that the at least one of the one or more conditions is fulfilled, or
e.g. in the update message, a status information, e.g. load information, associated with the third network node 113, based on that the at least one of the one or more conditions is fulfilled, or
e.g. in the first response message, an unsuccessful or failure to initialize the configuration procedure also referred to as a conditional forwarding configuration procedure, e.g. based on that the at least one of the one or more conditions is not fulfilled.

In other words, in some embodiments, the second network 112, transmits the message, e.g., the first response message to the first network node 111, as part of a reply for informing of whether or not the request to initialize the configuration procedure also referred to as a e.g. conditional forwarding configuration succeeded or failed. In some other embodiments, the message comprises the status information as an update message.

In some embodiments, the second network node 112, transmits the message, e.g. the update message, to the first network node 111 based on the whether or not the at least one of the one or more conditions is determined, e.g. verified, to be fulfilled.

In some embodiments, the second network node 112, transmits the update message wherein the update message comprises the obtained load information, e.g. as in action 1004, associated with the third network node 113.

In some embodiments, when the one or more conditions comprises at least one filtering condition, e.g. wherein the at least one filtering condition indicates, e.g. to the second network node 112, at least some status information, e.g. load information, not to be transmitted e.g. forwarded, to the first network node 111, the second network node 112 may transmit the update message by filtering the status information, e.g. load information, based on the filtering condition, before transmitting the update message to the first network node 111. In other words, the filtering condition may cause the second network node 112 to filter out status information, e.g. load information, which the first network node 111 does not want to receive.

The method will now be further explained and exemplified in below embodiments. These below embodiments may be combined with any suitable embodiment as described above.

### Example Method in the First Network Node 111

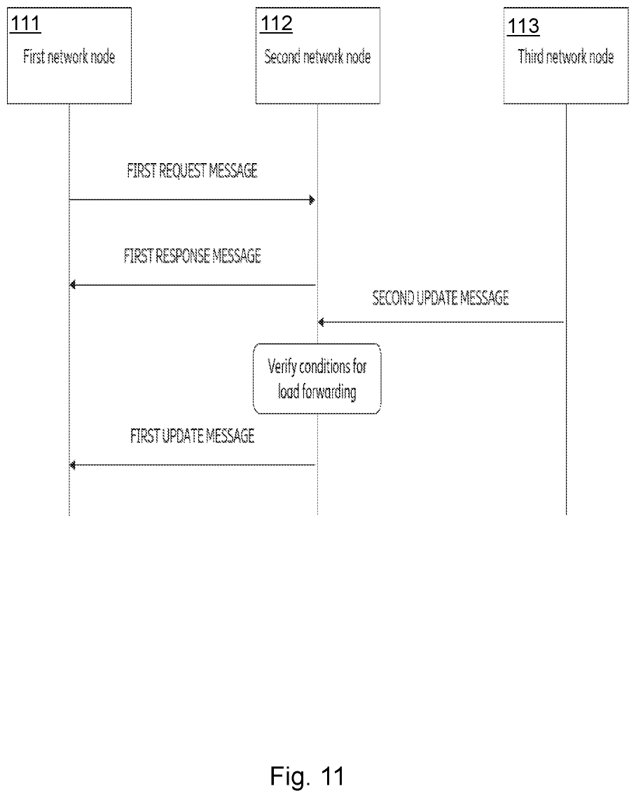

Embodiments herein may relate to an example method illustrated by FIG. 11. The example method is performed by the first network node 111 in the communications network 100, e.g. for requesting to the second network node 112 to provide load information associated with at least the third network node 113 when one or more conditions are fulfilled, the method may comprise any one or more of the following actions:
Transmitting a first request message to a second network node 112 to provide load information associated with at least a third network node 113. This relates to and may be combined, e.g. with action 903 above. The first request message may comprise one or more conditions to be fulfilled to trigger the second network node 112 to provide the requested load information, e.g. associated with the third network node 113. The one or more conditions may relate to the second network node 112. In some embodiments, the one or more conditions may relate to any one or more out of cells, SSB beams, and network slices of the second network node 112. The one or more conditions may relate to the third network node 113. In some embodiments, the one or more conditions may relate to any one or more out of cells, SSB beams, and network slices of the third network node 113. The one or more conditions may relate to the second network node 112 and to the third network node 113. In some embodiments, the one or more conditions may relate to any one or more out of: one or more cells, one or more SSB beams, and/or one or more network slices of the second network node 112 and of the third network node 113.
Receiving a first response message from the second network node 112. This relates to and may be combined, e.g. with action 904 above. The first response may e.g. comprise either
   A positive Acknowledgment (ACK) indicating a successful or partially successful initialization of a signaling procedure related to a conditional forwarding, from the second network node 112 to the first network node 111, of load information associated with at least a third network node 113, or
   A Negative Acknowledgment (NACK) indicating an unsuccessful or failure initialization of the signaling procedure related to the conditional forwarding, from the second network node 112 to the first network node 111, of load information associated with the at a third network node 113.
Optionally receiving a first update message from the second network node 112. This relates to and may be combined, e.g. with action 905 above. The update message may comprise one or more of the requested load information associated with at least a third network node 113.

In some embodiments, the first request message may comprise information element(s) indicating that the requested load information and/or the one or more conditions, e.g. as in Actions 901-905 and Actions 1001-1006 above, provided to trigger load information reporting is/are associated with a third network node 113, without necessarily specifying the identity of a particular network node, e.g. the third network node 113. The first network node 111 may request, for example, that the second network node 112 provides load information associated with one or more candidate PSCells of neighboring network nodes of the second network node 112 when one or more conditions indicated in the request message are fulfilled. The neighboring network nodes may comprise the third network node 113.

In some other embodiments, the first network node 111 may explicitly indicate the identity of at least a third network node 113. In some embodiments, the first network node 111 may explicitly indicate the identity of at least a radio cell of the third network node 113. In these embodiments, the third network node 113 may be a neighbor of the second network node 112. In one example, the indicated third network node 113 and/or associated radio cell, may be considered by the first network node 111 or by the second network node 112 as potential candidates for Carrier Aggregation (CA), for Multi-Radio Dual Connectivity (MR-DC). These two embodiments will further be explained by embodiments herein. The one or more conditions, e.g. for triggering the reporting of the requested load information, e.g. as in Actions 901-905 and Actions 1001-1006 above, may be associated with operations of the third network node 113 and/or of the second network node 112. In non-limiting examples, the one or more conditions provided by the first network node 111 to the second network node 112 e.g., for triggering the reporting of load information associated with a third network node 113 may be based on any one or more out of:
Measurements or predictions of capacity or load information associated with the third network node 113 and/or to the second network node 112, such as:
   Measurements or predictions of capacity or load associated with the third network node 113 and/or to the second network node 112,
   Measurements or predictions of resource status utilization or resource status availability at the third network node 113 and/or at the second network node 112,
   Measurements or predictions of hardware load or hardware capacity at the third network node 113 and/or at the second network node 112,
   Measurements or predictions of on one or more types of number of user devices, e.g. UEs such as the UE 120, present in a coverage area of radio cells, e.g. provided by the third network node 113 and/or of the second network node 112, or partitions thereof, such as a coverage area of an individual SSB beam or groups thereof, e.g. provided by the third network node 113 and/or of the second network node 112.
   Measurements or predictions of one or more traffic type or traffic load information associated with the coverage area of radio cells, or partitions thereof, e.g. such as the coverage area of individual SSB beams or groups thereof, of the third network node 113 and/or of the second network node 112, and/or
   Combinations thereof;
Measurements and/or predictions of coverage information associated with the third network node 113 and/or to the second network node 112;
Measurements or predictions of one or more traffic type or traffic load information associated with the third network node 113 and/or to the second network node 112; and
A combination thereof;

The one or more conditions to the third network node 113 and/or to the second network node 112, e.g. as in Actions 901-905 and Actions 1001-1006 above, may be defined, for instance, in terms of measurements or predictions of information related to any one or more out of:
radio cells, or SSB beams, or network slices of the second network node 112,
radio cells, or SSB beams, or network slices of the third network node 113, and
a combination thereof.

As non-limiting examples, which will be further explained in embodiments herein:
the FIRST REQUEST MESSAGE, e.g. as in action 903, 1001 above, may be implemented as any of an X2AP/XnAP/F1AP RESOURCE STATUS REQUEST, or an X2AP EN-DC RESOURCE STATUS REQUEST message.
the FIRST UPDATE MESSAGE, e.g. as in action 905, 1005 above, and/or a SECOND UPDATE MESSAGE, which will be further described by embodiments herein, may be implemented as any of an X2AP/XnAP/F1AP RESOURCE STATUS UPDATE message, or an X2AP EN-DC RESOURCE STATUS UPDATE message.
the FIRST RESPONSE MESSAGE, e.g. as in actions 904, 1005 above, may be implemented as any of an X2AP/XnAP/F1AP RESOURCE STATUS RESPONSE message, or an X2AP EN-DC RESOURCE STATUS RESPONSE message, or as any of an X2AP/XnAP/F1AP RESOURCE STATUS FAILURE message, or as an X2AP EN-DC RESOURCE STATUS FAILURE message.

### Method in the Second Network Node 112

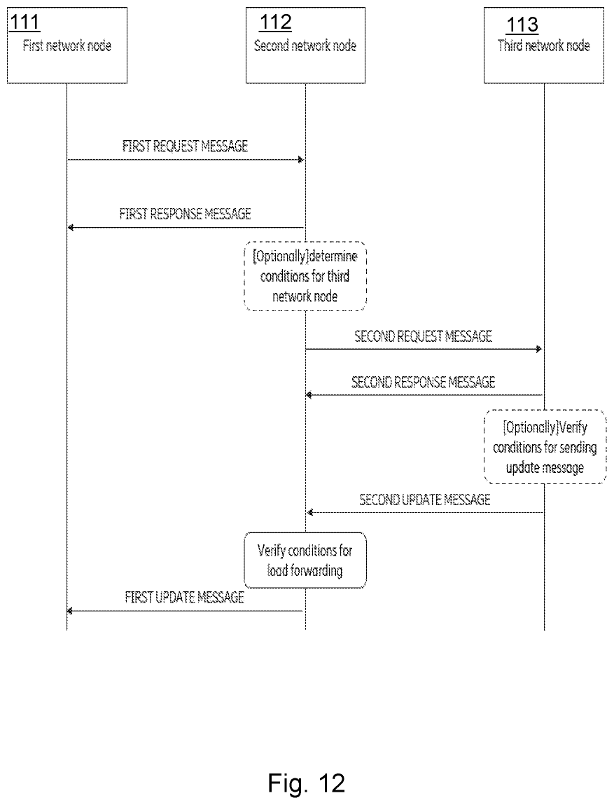

Embodiments herein may relate to an example method illustrated by FIG. 12. The example method is performed by the second network node 112 in the communications network 100, the method may comprise any one or more of the following actions:
Receiving a first request message from the first network node 111. This relates to and may be combined, e.g. with action 1001 above. The first request message may indicate to the second network node 112 to provide load information associated with at least a third network node 113. The first request message may comprise one or more conditions, e.g. as in Actions 1001-1006 above, that be fulfilled to trigger the second network node 112 to provide the requested load information, e.g. associated with the third network node 113.
Transmitting a first response message to the first network node 111. This relates to and may be combined, e.g. with action 1005 above. The first response message may e.g. comprise either
   A positive ACK indicating a successful or partially successful initialization of a signaling procedure related to a conditional forwarding, from the second network node 112 to the first network node 111, of load information associated with at least the third network node 113, or
   A NACK indicating an unsuccessful or failure initialization of the signaling procedure related to a conditional forwarding, from the second network node 112 to the first network node 111, of load information associated with the at the third network node 113.
Optionally transmitting a first update message to the first network node 111. This relates to and may be combined, e.g. with action 1006 above. The first update message may comprise one or more of the requested load information associated with at least a third network node 113.

FIG. 12 further illustrates an example embodiment here wherein the second network node 112 transmits a second request message to a third network node 113 upon receiving a first request message from the first network node 111. In some of these embodiments, the initialization of a load reporting procedure from the third network node 113 to the second network node 112 is triggered by and/or based on the first request message received by the second network node 112 from the first network node 111, e.g. as in action 1001 above. In some of these embodiments, methods performed by the second network node 112, e.g. as in actions 1001-1006 above, may further comprise any one or more out of:
Transmitting a second request message to the third network node 111. This relates to and may be combined, e.g. with Action 1004 above. The second request messages indicating a request of load information associated with the third network node 113, e.g. based on, and/or triggered by, the first request message.
Receiving a second response message from the third network node 113. This relates to and may be combined, e.g. with Action 1004 above. The second response message may e.g. comprise either
   An ACK indicating a successful or partially successful initialization of a signaling procedure related the requested load information, or
   A NACK indicating an unsuccessful or failure initialization of the signaling procedure related to the requested load information.
Optionally receiving a second update message from the third network node 113, e.g., related to Action 1004 above. The second update message may comprise one or more of the requested load information associated with at least a third network node 113.

Similar to the case of the FIRST REQUEST/RESPONSE/UPDATE MESSAGES, as described above, as non-limiting examples, the SECOND REQUEST/RESPONSE/UPDATE MESSAGES may be implemented as any of a X2AP/XnAP/F1AP RESOURCE STATUS REQUEST/RESPONSE/UPDATE message, respectively, or as an X2AP EN-DC RESOURCE STATUS REQUEST/RESPONSE/UPDATE message, respectively.

### Methods of the First Network Node 111

Below follows further embodiments exemplifying methods performed by the first network node 111.

The first network node 111 may be comprised in the wireless communications network 100, e.g. for requesting to the second network node 112 to provide load information associated with at least the third network node 113 when one or more conditions are fulfilled, the method may comprise any one or more out of e.g. comprising:
Transmitting a first request message to the second network node 112 to provide load information associated with at least the third network node 113. This relates to and may be combined, e.g. with action 903 above. The first request message may comprise one or more conditions to be fulfilled for triggering the second network node 112 to provide the requested load information, e.g. associated with the third network node 113. The one or more conditions may relate to the second network node 112. In some embodiments, the one or more conditions may relate to any one or more out of cells, SSB beams, and network slices of the second network node 112. The one or more conditions may relate to the third network node 113. In some embodiments, the one or more conditions may relate to any one or more out of cells, SSB beams, and network slices of the third network node 113.
   Prior to transmitting a first request message, the first network node 111 may check conditions concerning the first network node 111. This relates to and may be combined, e.g. with Actions 901, 902. This may be since the first network node 111 may need to receive information of the third network node 113 via the second network node 112 only when the first network node 111 determines that it may be beneficial to find an alternative network node to serve a user, e.g. the UE 120. This may happen, e.g.:
      when the first network node 111 determines that Quality of Service (QOS) fulfillment is at risk, or
      when an evolution over time of one or more load metrics e.g. Composite Available Capacity (CAC) at the first network node 111, indicates that one or more resources, e.g. network resources such as bandwidth, PRB utilization, etc., at the first network node 111 may be depleted or may become too scarce, e.g. may decrease below a threshold.
Receiving a first response message from the second network node 112. This relates to and may be combined, e.g. with action 904 above. The first response message e.g., may comprise either:
   An ACK indicating a successful or a partially successful initialization of a signaling procedure related to a conditional forwarding, from the second network node 112 to the first network node 111, of load information associated with at least the third network node 113, or
   A NACK indicating an unsuccessful or failed initialization of a signaling procedure related to a conditional forwarding, from the second network node 112 to the first network node 111, of load information associated with the third network node 113.
   Optionally receiving a first update message, e.g. as in action 905 above, from the second network node 112. The first update message may comprise one or more of the requested load information associated with the third network node 113.

In some embodiments, the first network node 111 determines actions related to radio optimization or radio network configuration on the basis of the content of the first update message received from the second network node 112, e.g. related to action 905 above. Non-limiting examples of optimization actions may comprise:
promote or penalize a handover of one or more UEs from the first network node 111 to the second network node 112. For example, the first network node 111 may determine that at least one UE, e.g. comprising the UE 120, may be handed over to a cell of the second network node 112, and e.g. aggregated to one or more cells of the third network node 113 for which the second network node 112, e.g. wherein the second network node 112, the third network node 113 and/or at least one of the one or more cells, may be related to a certain amount of measured or predicted available resources, or a highest amount or a second highest amount of measured or predicted available resources, or at least a minimum amount of measured or predicted available resources, or a measured or predicted available resources whose level is comprised between a first threshold and a second threshold. In some embodiments, the measured or predicted available resource may relate to a highest amount, a second highest amount, or at least a certain amount of CAC in Uplink and/or Downlink.
promote or penalize a release with redirect of one or more UEs, e.g. comprising the UE 120, from a first carrier frequency served by the first network node 111 to a second carrier frequency served by the second network node 112 or the third network node 113.
setup or modify a connection for a UE, e.g. the UE 120, wherein the new or modified connection for the UE may use at least one of one or more cells of the third network node 113.
establish and/or remove a control plane and/or a user plane connection between the first network node 111 and the third network node 113.

In some embodiments, the FIRST REQUEST MESSAGE, e.g., as in actions 903, 1001, may comprise an implicit or explicit indication of a third network node 113. In some embodiments, the first request message, e.g., as in actions 903, 1001, may comprise one or more information elements indicating that a requested load information and/or the one or more conditions provided to trigger load information reporting is/are associated with the third network node 113, without necessarily specifying the identity of the third network node 113. The first network node 111 may request, for example, that the second network node 112 provides load information associated with one or more candidate PSCells of neighboring nodes of the second network node 112 when one or more conditions indicated in the request message are fulfilled. The neighboring nodes may comprise the third network node 113.

In an example scenario, the method related to EN-DC, wherein the first network node 111 is an eNB, the second network node 112 is an eNB and the third network node 113 is an en-gNB. The first network node 111 may in this example scenario request the second network node 112 to provide to the first network node 111 a list of cells of the third network node 113 that may be used in EN-DC operation together with cells of the second network node 112, to determine resources of cells of the third network node 113 that may be used together with resources of cells of the second network node 112. In other words, resources of cells of the third network node 113 and resources of cells of the second network node 112 may in this scenario be aggregated. A condition, e.g. as part of the one or more conditions as in Actions 901-905 above, that may be included in the request sent by the first network node 111 may be e.g. a threshold level for a CAC in UL and/or DL. Alternatively, any other suitable individual load metric e.g. as described in XnAP/X2AP RESOURCE STATUS UPDATE, or X2AP EN-DC RESOURCE STATUS UPDATE, or a combination of more than one load metric may be used for the condition. The condition may need to be fulfilled by a cell of the third network node 113 for the third network node 113 to be indicated as a potential candidate for resource aggregation to the first network node 111.

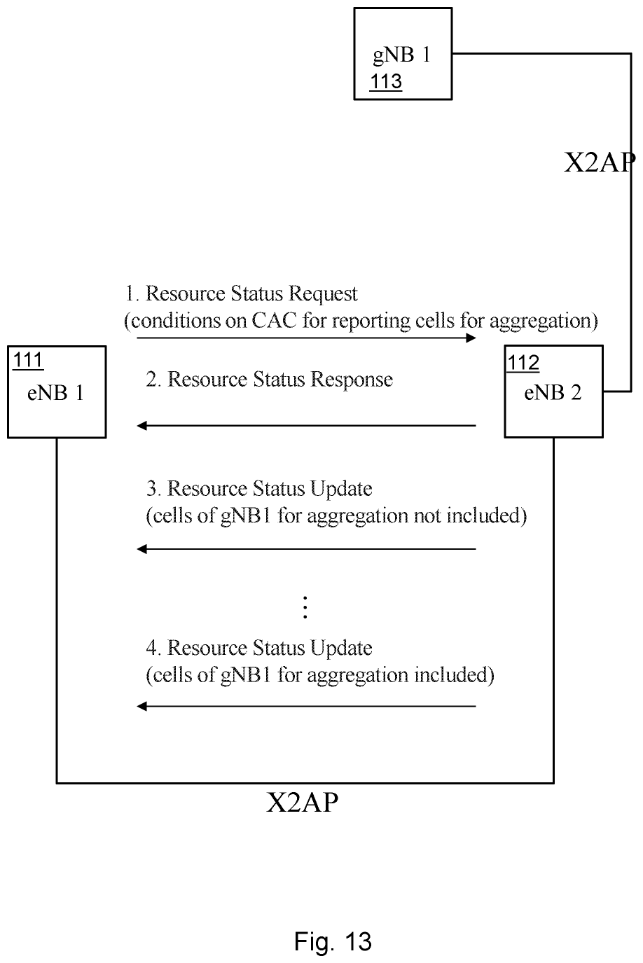

The example scenario is illustrated in FIG. 13, wherein the first network node 111 and the second network node 112 are eNBs, respectively eNB1 and eNB2, wherein the third network node 113 is an en-gNB, also referred to as en-gNB3, also referred to as gNB1, e.g. as illustrated by FIG. 13. eNB1 requests to eNB2 to obtain load information for at least one cell of en-gNB3 and includes in the request a condition on a threshold for CAC, e.g. in UL and/or DL, indicating to eNB2 to include a cell of en-gNB3 if the CAC of that cell is above the threshold.

In some embodiments, the first request message, e.g. as in actions 903, 1001 above, may comprise information element(s) indicating that the requested load information and/or the conditions provided to trigger load information reporting is/are associated with at least the third network node 113. Thereby, the first request message may explicitly indicate an identifier of the third network node 113 and/or an identifier of a radio cell of the third network node 113 and/or an identifier/index of the coverage area of a downlink reference signal beam of the third network node 113, e.g. for which load information is requested and/or for which triggering condition for load information reporting are provided as part of the first request message, e.g. as in actions 903, 1001 above. An example of a reference signal beam coverage area may comprise a SSB beam coverage area or a SSB beam index coverage area. In these embodiments, the first request message, e.g. related to actions 903, 1001 above, may be transmitted by the first network node 111 to the second network node 112 and may indicate to the second network node 112 any one or more out of:
An identifier of at least the third network node 113 for which conditions are provided for reporting load information to the first network node 111
An identifier of at least a radio cell associated with at least the third network node 113 for which conditions are provided for reporting load information to the first network node 111,
An identifier of the coverage area of at least one SSB beam, such as a SSB beam index, of a group of SSB beams associated with at least the third network node 113, e.g. for which conditions are provided for reporting load information to the first network node 111,
An identifier of at least a network slice or a group of network slices associated with at least the third network node 113 for which conditions are provided for reporting load information to the first network node 111, and
A combination thereof.

In one example, the indicated third network node 113 or the associated radio cell or the associated downlink reference signal beam coverage area, may be considered by the first network node 111 or by the second network node 112 as potential candidates for Carrier Aggregation, for multi-radio dual connectivity.

In some embodiments, the first network node 111 may determine an identity of cells or SSB beams or CSI-RS beams of the third network node 113 neighboring the second network node 112, e.g. for which load information is requested to be provided from the second network node 112 to the first network node 111, based on a coverage criteria. In one example, the first network node 111 may use radio related measurements, e.g. cell level measurements, SSB level measurements, or CSI-RS measurements, such as RSRP, RSRQ, RSSI, received/obtained at the first network node 111 for at least a cell, or at least an SSB beam, or at least a CSI-RS beam, of the third network node 113, e.g. to determine that such cell(s) or SSB beam(s) or CSI-RS beam(s) of the third network node 113 is (are) to be included in, or excluded from, a list of cells, or a list of SSB beams, or a list of CSI-RS beams, for which load information is requested to be provided from the second network node 112 to the first network node 111. In some of these embodiments, determining the identity may be based on e.g. any one or more out of:
a comparison of radio measurements related to cell(s) and/or SSB/CSI-RS beam(s) of the third network node 113 w.r.t. one or more thresholds, e.g. RSRP of a cell higher than a threshold, and
one or more radio measurements of cell(s) and/or SSB/CSI-RS beam(s) of the third network node 113, e.g. offset better, or worse, compared to one or more radio measurements of cells(s) and/or SSB/CSI-RS beam(s) of the first network node 111, or of the second network node 112, e.g. RSRP of a cell of the third network node 113 may be X dB offset better, e.g. higher or lower, than the RSRP of a cell of the second network node 112.

In some embodiments, the FIRST REQUEST MESSAGE, e.g. as in actions 903, 1001 above, may be related to one or more conditions for load transfer. The first request message transmitted by the first network node 111 to the second network node 112 may provide to the second network node 112 the one or more conditions, e.g. as in actions 903, 1001 above, that may or shall be fulfilled to trigger reporting, from the second network node 112 to the first network node 111, of all or part of the requested load information associated with the third network node 113, or radio cells, partitions thereof, of the third network node 113.

The one or more conditions, e.g. as in actions 901-905, 1001-1006 above, for triggering the reporting of the requested load information may be associated with operations of the third network node 113 and/or of the second network node 112. In non-limiting examples, the one or more conditions provided by the first network node 111 to the second network node 112 for triggering the reporting of load information associated with the third network node 113 may be based on any one or more out of:
One or more measurements or predictions of capacity or load information associated with the third network node 113 and/or to the second network node 112,
one or more measurements and/or predictions of coverage information associated with the third network node 113 and/or to the second network node 112,
one or more measurements or predictions of one or more traffic type or traffic load information associated with the third network node 113 and/or to the second network node 112, and
a combination thereof.

The one or more conditions, e.g. association reporting conditions to the third network node 113 and/or to the second network node 112 may be defined, for instance, in terms of measurements or predictions of information related to:
one or more radio cells, or SSB beams, or network slices of the second network node 112, or
one or more radio cells, or SSB beams, or network slices of the third network node 113, or
a combination thereof.

In some embodiments, predictions of load information associated with one or more cells or one or more SSB beams or one or more network slices of the second network node 112 or the third network node 113, or combinations thereof, may be determined based on a historical load information, e.g. using any suitable estimation method, such as maximum likelihood estimation, Kalman filtering, etc., or by means of machine learning, such as a regression algorithm or a functional approximator, such as a neural network, trained on historical data to provide an estimate of the future load information. Similar methods may be used to provide predictions of coverage information.

In one example, the one or more conditions triggering load information reporting, e.g. as in Actions 901-905, 1001-1006 above, from the second network node 112 to the first network node 111, may be based on one or more operation, information, and/or metric associated only to the third network node 113. In another example, the one or more conditions may be associated with one or more operation, information, and/or metric associated with both the second network node 112 and the third network node 113. Hereafter we describe the two cases in more details.

1. Conditions Related to Information Associated with Third Node Only

In some embodiments, the one or more conditions provided by the first request message, e.g. as in actions 903, 1001 above, to the second network node 112 for triggering the reporting, to the first network node 111, of all or part of the requested load information associated with the third network node 113 may be associated with one or more load information of the third network node 113. Examples may include one or more of the following:
One or more conditions based on one or more measurements or predictions of at least one capacity metric at the third network node 113. The at least one capacity metric may be any of CAC, a capacity value, a transport network capacity metric, e.g. as defined by 3GPP LTE system or 3GPP NR systems, or a combination thereof. The one or more conditions relating to available capacity may be expressed per cell of the third network node 113, per SSB beam or group of SSB beam coverage area at the third network node 113, per network slice, e.g. an S-NSSAI, or group of network slices, or combinations thereof. In addition, the one or more conditions relating to available capacity may be defined for an aggregation of radio cells, frequency band and combination thereof at the third network node 113.
In one example, the one or more conditions may be defined to relate to that CAC in Uplink and/or in Downlink of at least one cell, or at least a portion thereof, of the third network node 113 is above or below a first threshold, or between the first threshold and a second threshold.
In another example, the one or more conditions may be defined to relate to that a Slice Available Capacity in Uplink and/or in Downlink of at least one cell, or at least a portion thereof, of the third network node 113 is above or below a third threshold, or between the third threshold and a fourth threshold.
   The one or more conditions may be based on one or more measurements or predictions of resource status utilization or resource status availability at the third network node 113, such as e.g. the radio resource status as defined as defined by 3GPP LTE system or 3GPP NR systems, or a combination thereof. The one or more conditions relating to resource status utilization or resource status availability may be expressed per cell of the third network node 113, per SSB beam or group of SSB beam coverage area at the third network node 113, per network slice or group of network slices, or combinations thereof. In addition, the one or more conditions relating to resource status utilization or resource status availability may be defined for an aggregation of radio cells, frequency band and combination thereof at the third network node 113.
In some embodiments, the one or more conditions may be defined to relate to that an GBR/non-GBR PRB usage in Uplink and/or in Downlink of at least one cell, or at least a portion thereof, of the third network node 113 is above or below a fifth threshold, or between the fifth threshold and a sixth threshold.
In some other embodiments, the one or more conditions may be defined to relate to that PDCCH CCE scheduling in Uplink and/or in Downlink of at least one cell, or at least a portion thereof, of the third network node 113 is above or below a seventh threshold, or between the seventh threshold and an eight threshold.
   In some other embodiments, at least one of the one or more conditions may be based on measurements or predictions of one or more types of number of user devices present in the coverage area of radio cells, e.g. UEs such as the UE 120, per coverage area of individual SSB beams or groups thereof, per network slice or group of network slices of the third network node 113, or a combination thereof. In addition, the number of conditions on one or more types of number of UEs at the third network node 113 may be defined for an aggregation of radio cells, frequency band and combination thereof at the third network node 113. A different types of number of UEs for which triggering conditions for load information reporting may be defined e.g. as part of the one or more conditions of Actions 901-905, 1001-1006 above, may include one or more or a combination of:
A number of UEs,
a number of UE in RRC connected mode or number of RRC connections,
a number of inactive UE,
a number of active UEs,
a number of UEs with only LTE capability,
a number of UEs with NG-RAN (NR) capability,
a number of active UE with only LTE capability,
a number of active UEs with NG-RAN (NR) capability,
a number of UEs with MRDC capability, and
a number of active UEs with MRDC capability.
   In some other embodiments, at least one of the one or more conditions may be based on measurements or predictions of hardware load or hardware capacity at the third network node 113.
   The one or more conditions may comprise conditions relating to a combination of conditions at the third network node 113, e.g. related to metrics such as to capacity, resource status utilization, resource status availability, types or number of user devices, hardware load, hardware capacity. In some embodiments, a condition may be represented by a number of active UEs with NR capability for a given S-NSSAI.
   Additional indications may indicate whether an additional filtering criteria should apply in addition to any or all or a combination of the conditions mentioned above, such as to any one or more out of:
include, or exclude, information for “X” cells/SSB beams/CSI-RS beams of the third network node 113 whose level of resources may be the highest or lowest according to one or more load metrics,
include, or exclude, information for the “X” cells/SSB beams/CSI-RS beams of the third network node 113 whose level of resources may be higher than given threshold(s) according to one or more load metrics,
include, or exclude, information for the “X” cells/SSB beams/CSI-RS beams of the third network node 113 whose level of resources may be lower than given threshold(s) according to one or more load metrics, and
include, or exclude, information for the “X” cells/SSB beams/CSI-RS beams of the third network node 113 whose level(s) of resource(s) may be comprised between a first threshold (a first set of thresholds) and a second threshold (a second set of thresholds) for a (more) load metric(s).

In some embodiments, the one or more conditions provided by the first request message to the second network node 112 to trigger the reporting of all or part of the requested load information associated with a third network node 113 to the first network node 111 may be associated with a coverage of cells and/or beams of the third network node 113.

In one example, a triggering condition of the one or more conditions may require that:
when at least one condition of the one or more conditions, e.g. defined for the coverage of cells and/or beams of the third network node 113, is fulfilled, trigger the reporting, from the second network node 112 to the first network node 111, of load information associated with the third network node 113.
   2. Conditions Related to Information Associated with Both Second Network Node 112 and Third Network Node 113

In some embodiments, the one or more conditions provided by the first request message to the second network node 112 to trigger the reporting of all or part of the requested load information associated with a third network node 113 to the first network node 111 may be associated with one or more measurements or predictions of one or more load information of the second network node 112 and of the third network node 113.

In one example, a triggering condition, e.g. of the one or more conditions, may require that:
when at least one condition defined for a load information metric related to the second network node 112 is fulfilled, and, when at least one condition defined for a load information metric related to the third network node 113 is fulfilled, trigger the reporting, from the second network node 112 to the first network node 111, of load information associated with the third network node 113.

In another example, a triggering condition of the one or more conditions may require that an aggregation of load information related to the second network node 112 and of the third network node 113 fulfils a criteria to trigger the reporting, from the second network node 112 to the first network node 111, of load information associated with the third network node 113.

One or more triggering conditions, e.g. of the one or more conditions, based on an aggregation of load information or a combination of load information associated with the second and to third network node 113 may be defined by any one or more out of:
Capacity information, such as composite available capacity,
Resource status utilization or resource status availability,
One or more types of number of user devices present in the coverage area of radio cells, per coverage area of individual SSB beams or groups thereof, per network slice or group of network slices, or combinations thereof,
Hardware load or hardware capacity, and
A combination of conditions at the third network node 113 on metrics related to capacity, resource status utilization, resource status availability, types or number of user devices, hardware load, hardware capacity.

In one example, a triggering condition, e.g. of the one or more conditions, based on an aggregation of load information of the second network node 112 and of the third network node 113 may refer an aggregate capacity, such as a composite available capacity, that the second and the third network node 113 may be able to provide.

The one or more conditions relating to an aggregate capacity may be requested, for instance on a per cell basis and/or on a per SSB coverage area basis. For example, the first network node 111 may provide one or more triggering conditions defined on the average CAC per cell that the second and third network node 113 may provide together wherein the average may be computed considering the CAC of individual cells of both the second and third network node 113. The first request message may in some embodiments additionally provide a list of radio cells or SSB coverage are of the first and/or the second network node 112 that may be used to compute an aggregate capacity.

In some embodiments, an aggregate triggering condition, e.g. of the one or more conditions, may be defined in terms of an average or a total i.e., sum, of resource status utilization or resource status availability at the second network node 112 and at the third network node 113, on a per cell basis, on a per SSB or group of SSB basis, on a per network slice or group of network slices basis.

In some embodiments, an aggregate triggering condition, e.g. of the one or more conditions, may be defined for in terms the average or the total number of user devices present in the coverage area of radio cells, or in the coverage area of individual SSB beams or groups thereof, or per network slice or group of network slices, or combinations thereof, at both the second network node 112 and the third network node 113. Similarly to other embodiments, such aggregate triggering condition may be defined for different types of number of user devices, e.g. UEs such as the UE 120, such as:
A number of UEs,
a number of UE in RRC connected mode or number of RRC connections,
a number of inactive UE,
a number of active UEs,
a number of UEs with only LTE capability,
a number of UEs with NG-RAN (NR) capability,
a number of active UE with only LTE capability,
a number of active UEs with NG-RAN (NR) capability,
a number of UEs with MRDC capability, and
a number of active UEs with MRDC capability.

In some embodiments, the one or more conditions provided by the first request message to the second network node 112 to trigger the reporting of all or part of the requested load information associated with a third network node 113 to the first network node 111 may be associated with a coverage of cells and/or beams of the second network node 112 and of the third network node 113.

In one example, a triggering condition, e.g. as part of the one or more conditions, may require that:
at least one condition defined for the coverage of cells and/or beams of the second network node 112 is fulfilled and
at least one condition defined for the coverage of cells and/or beams of the third network node 113 is fulfilled,
for triggering a reporting, from the second network node 112 to the first network node 111, of load information associated with the third network node 113, e.g. as in action 905, 1006 above.

In another example, a triggering condition, e.g. of the one or more conditions, may require that an aggregation of coverage information related of at least a cell (or group thereof) and/or at least a beam (of group thereof) of the second network node 112 and of the third network node 113 fulfils a criteria to trigger the reporting, from the second network node 112 to the first network node 111, of load information associated with the third network node 113.

### Methods of the Second Network Node 112

Embodiments herein may be performed by the second network node 112 in the communications network 100 for transmitting to the first network node 111 load information associated with at least the third network node 113 when the one or more conditions are fulfilled. In some embodiments, the methods, e.g. according to actions 901-905, 1001-1006 above, may comprise any one or more out of:
Receiving a first request message from a first network node 111, e.g. as in action 1001 above, e.g., to provide load information associated with at least the third network node 113. The first request message may comprise one or more conditions to be fulfilled to trigger the second network node 112 to provide the requested load information, associated with the third network node 113. The one or more conditions may refer to the second network node 112, or cells or SSB beams of the second network node 112, or to the third network node 113, or cells or SSB beams of the third network node 113, or a combination thereof.
Transmitting a first response message to the first network node 111, e.g. as in actions 1005, 1006 above. The first response message e.g. comprising either:
   A positive acknowledgment (ACK) indicating a successful or a partially successful initialization of a signaling procedure related to a conditional forwarding, from the second network node 112 to the first network node 111, of load information associated with at least a third network node 113, or
   A negative acknowledgment (NACK) indicating an unsuccessful or failed initialization of the signaling procedure related to a conditional forwarding, from the second network node 112 to the first network node 111, of load information associated with the at a third network node 113.
   Optionally, e.g. as in action 1006 above, transmitting a first update message to the first network node 111 comprising one or more of the requested load information associated with at least a third network node 113.

In some embodiments, the methods of the second network node 112 may use the embodiments related to conditions for load transfer described herein for the first network node 111. Additional embodiments are described hereafter.
One or more conditions relating to coverage of cells and/or beams of the third network node 113. The second network node 112 may determine the identity of cells or SSB beams or CSI-RS beams of the third network node 113 neighboring the second network node 112, e.g. for which load information is to be provided from the second network node 112 to the first network node 111, e.g. based on a coverage criteria.

In one example, the second network node 112 may use and/or obtain radio related measurements, e.g. cell level measurement, such as RSRP, RSRQ, RSSI, received at the second network node 112 for at least a cell, or at least an SSB beam, or at least a CSI-RS beam, of a third network node 113 and may determine that such cell(s) or SSB beam(s) or CSI-RS beam(s), e.g. of the third network node 113, is/are to be included in, or excluded from, a list of cells, or a list of SSB beams, or a list of CSI-RS beams, for which load information is to be provided from the second network node 112 to the first network node 111. In some these embodiments, determining may be performed using the same criteria described for the first network node 111 above.
One or more conditions relating to energy savings for the third network node 113. The second network node 112 may determine an identity of cells or SSB beams or CSI-RS beams of a third network node 113 neighboring the second network node 112 for which load information is requested to be provided from the second network node 112 to the first network node 111, e.g. based on an energy saving criteria. In one example, the second network node 112 may use information received from the third network node 113 that at least one of its cells is deactivated due to energy savings and exclude said cell(s) from a list of cells for which load information is to be provided to the first network node 111.
One or more additional indications may indicate whether additional filtering criteria should apply in addition to any or all or a combination of the conditions mentioned above, such as:
   include, or exclude, information for “X” cells/SSB beams/CSI-RS beams of the third network node 113 whose level of resources is the highest or lowest according to one or more load metrics,
   include, or exclude, information for the “X” cells/SSB beams/CSI-RS beams of the third network node 113 whose level of resources is higher than given threshold(s) according to the one or more load metrics,
   include, or exclude, information for the “X” cells/SSB beams/CSI-RS beams of the third network node 113 whose level of resources is lower than given threshold(s) according to the one or more load metrics,
   include, or exclude, information for the “X” cells/SSB beams/CSI-RS beams of the third network node 113 whose level(s) of resource(s) is (are) comprised between a ninth threshold, or a ninth set of thresholds, and a tenth threshold, or a tenth set of thresholds, e.g. for one or more load metric(s).

In some embodiments, e.g. as illustrated in FIG. 12, the second network node 112, e.g. upon receiving the first request message from the first network node 111, e.g. as in action 1001 above, may additionally comprise any one or more out of:
Transmitting a second request message to a third network node. The second request messages indicating a request for load information associated with the third network node 113. The second request message may be based on the first request message.
Receiving a second response message from the third network node 113, e.g. comprising either:
A positive acknowledgment (ACK) indicating a successful or partially successful initialization of a signaling procedure related the requested load information.
A negative acknowledgment (NACK) indicating an unsuccessful or failure initialization of the signaling procedure related to the requested load information.
Optionally, receiving a second update message from the third network node 113 comprising one or more of the requested load information associated with at least a third network node 113.

In some of these embodiments, the initialization of a load reporting procedure, e.g. the signaling procedure, from the third network node 113 to the second network node 112 may be triggered by and/or based on the first request message received by the second network node 112 from the first network node 111. In some embodiments, the second network node 112 may determine one or more second triggering conditions to be fulfilled to trigger the third network node 113 to provide the requested load information to the second network node 112, wherein the one or more second conditions may be based on information received by the second network node 112 within the first request message. Thereby, in some embodiments, the second request message may comprise one or more second triggering conditions to be fulfilled, e.g. to trigger the third network node 113 to provide the requested load information to the second network node 112. The one or more second conditions may be based on information received by the second network node 112 within the first request message. For example, the one or more second conditions provided by the second request message to the third network node 113 may relate to one or more of:
Measurements and/or predictions of load information associated with cells, or SSB beams, or network slices of the third network node 113,
Measurements and/or predictions of coverage associated with or cells, or SSB beams of the third network node 113, and
e.g. the one or more conditions e.g. that the second network node 112 receives as part of the first request message.

### Mapping to Network Architectures

Non-limiting use cases where the method could be applied may comprise any one of:
The first/second/third network nodes 111, 112, 113 all of the same kind of network node, e.g., all are eNBs, gNBs, etc.
The first network node 111 is a gNB-DU1, the second network node 112 is a gNB-CU, the third network node 113 gNB-DU2.
The first network node 111 is a gNB-DU, the second network node 112 is a first gNB-CU, e.g., gNB-CU1, the third network node 113 is a second gNB-CU, e.g. gNB-CU2.
The first network node 111 is a gNB-DU, the second network node 112 is a gNB-CU, the third network node 113 is an eNB.
The first network node 111 is a gNB-DU, the second network node 112 is a gNB-CU, the third network node 113 is a gNB/gNB-CU.
The first network node 111 is an eNB-DU, the second network node 112 is an eNB-CU, the third network node 113 is an gNB/gNB-CU.

The figures described hereafter provide illustrations of possible implementations of the method, e.g. according to actions 901-905, 1001-1006 above, e.g. for the different use case listed in examples above. Scenarios and examples illustrated by below figures may be based on the example scenario illustrated by FIG. 12. The scenarios and examples illustrated by below figures may also be based on a more generic scenario, e.g. as illustrated by FIG. 11.

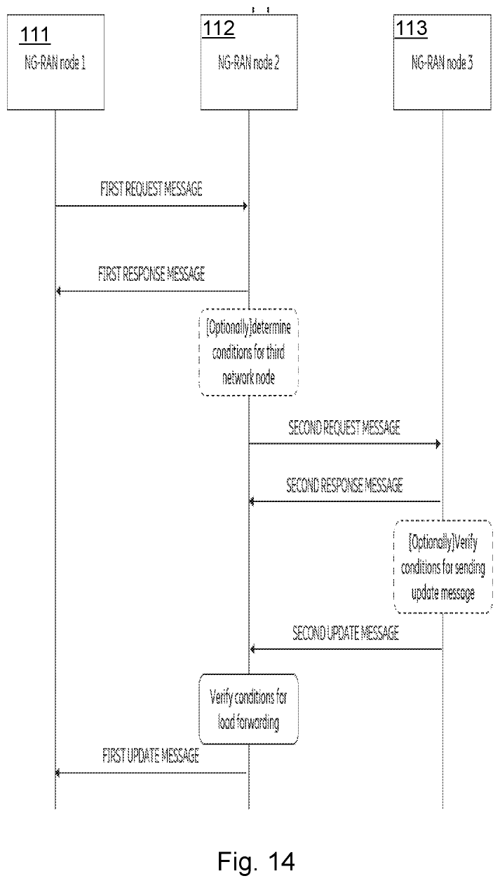

Non-limiting illustration for use case 1: Intra NG-RAN system example using Xn interface FIG. 14 the example scenario of an intra NG-RAN system example using Xn interface, wherein the first, second, and third network nodes 111, 112, 113 are NG-RAN nodes connected by an Xn interface.

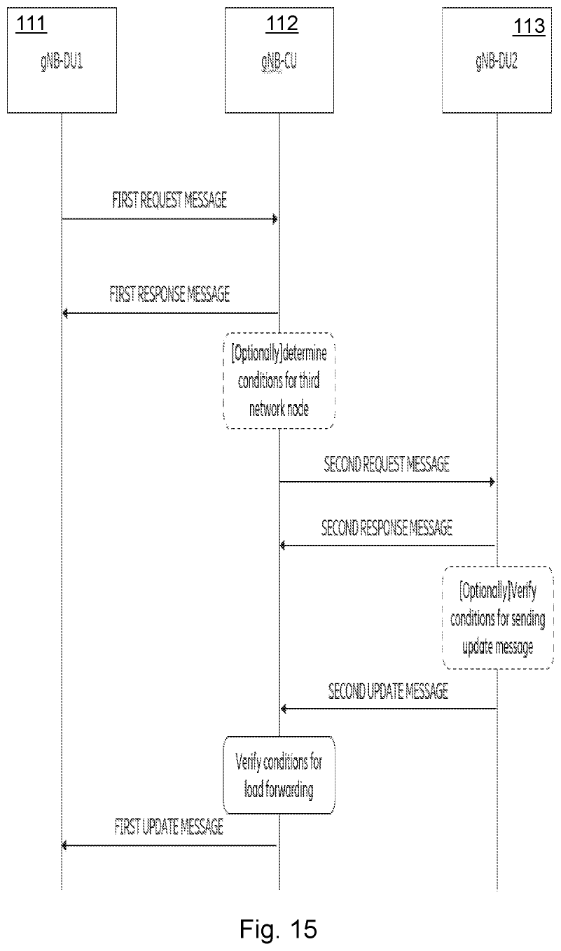

Non-limiting illustration for use case 2: NG-RAN node with split architecture involving F1 interface. FIG. 15 the example scenario of a NG-RAN node with a split architecture involving F1 interface, wherein the first network node 111 is a first gNB-DU, e.g., gNB-DU1, the second network node 112 is a gNB-CU, e.g., gNB-CU, and the third network node 113 is a second gNB-DU, e.g., gNB-DU2. In these scenarios, the communication between the first network node 111 and second network node 112, and between the second and the third network node 113, occurs over a F1 interface of the NG-RAN system.

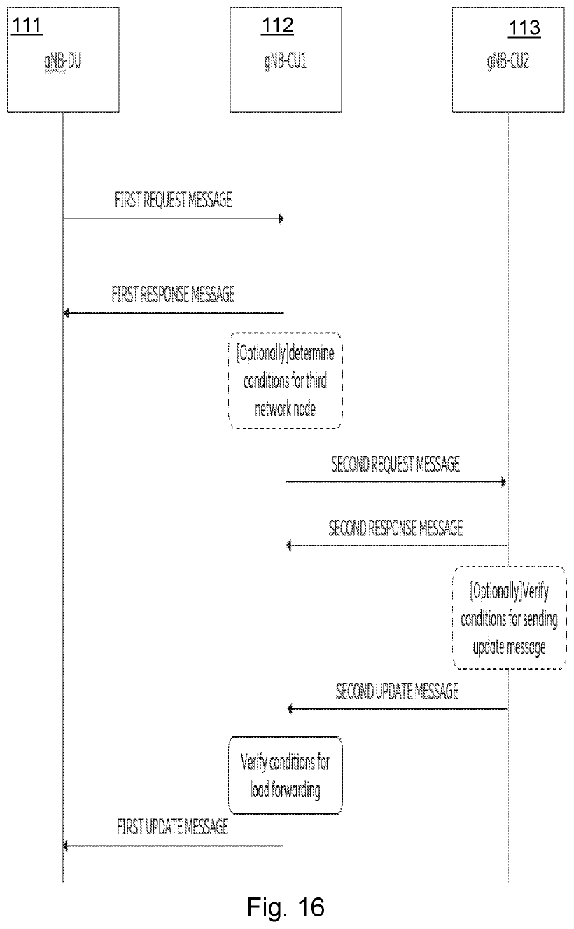

Non-limiting illustration for use case 3: Intra NG-RAN system with split architecture involving F1 and Xn. FIG. 16 illustrates the example scenario of an intra NG-RAN system with split architecture involving F1 and Xn, wherein the first network node 111 is a gNB-DU, the second network node 112 is a first gNB-CU, e.g., gNB-CU1, and the third network node 113 is a second gNB-CU, e.g., gNB-CU2. In these scenarios, the communication between the first network node 111 and the second network node 112 occurs over a F1 interface of the NG-RAN system, whereas the communication between the second network node 112 and the third network node 113 occurs over a Xn interface of the NG-RAN system.

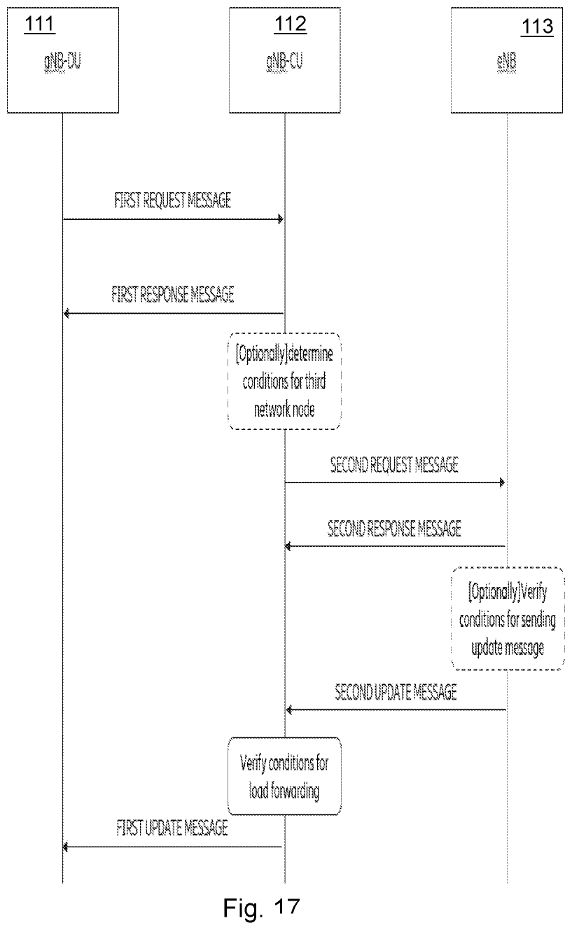

Non-limiting illustration for use case 4: Intra-system application between NG-RAN node with split architecture and LTE using F1 and X2 architecture. FIG. 17 illustrates the example scenario of an intra-system application between NG-RAN node with split architecture and LTE using F1 and X2 architecture, wherein the first network node 111 is a gNB-DU, the second network node 112 is a gNB-CU and the third network node 113 is an eNB of an E-UTRAN system. In this scenario, the communication between the first network node 111 and the second network node 112 occurs over a F1 interface of the NG-RAN system. The communication between the second network node 112 and the third network node 113 occurs over a X2 interface.

In some examples of implementation:
the FIRST REQUEST MESSAGE, e.g. as in actions 903, 1001 above, may be realized with an X2AP RESOURCE STATUS REQUEST, or an X2AP EN-DC RESOURCE STATUS REQUEST, or an XnAP RESOURCE STATUS UPDATE, or an F1AP RESOURCE STATUS REQUEST.
the FIRST UPDATE MESSAGE, e.g. as in actions 905, 1006 above, may be realized with an X2AP RESOURCE STATUS UPDATE, or an X2AP EN-DC RESOURCE STATUS UPDATE, or an XnAP RESOURCE STATUS UPDATE, or an F1AP RESOURCE STATUS UPDATE.

### Examples of Implementation—X2AP

Below follows examples of signalling parameters as in embodiments herein. In particular, underlined parts below may be additions for how to signal parameters e.g. as in embodiments herein.

### Resource Status Request

This message is sent by an eNB1 to neighbouring eNB2 to initiate the requested measurement according to the parameters given in the message.
Direction: eNB1→eNB2.

In some of these embodiments, the eNB1 may be the first network node 111, and the eNB2 may be the second network node 112.

| | | | IE type and | | | Assigned |
|---|---|---|---|---|---|---|
| IE/Group Name | Presence | Range | reference | Semantics description | Criticality | Criticality |
| Message Type | M | | 9.2.13 | | YES | reject |
| eNB1 | M | | INTEGER | Allocated by eNB₁ | YES | reject |
| Measurement ID | | | (1 . . . 4095, . . .) | | | |
| eNB2 | C- | | INTEGER | Allocated by eNB₂ | YES | ignore |
| Measurement ID | ifRegistration | | (1 . . . 4095, . . .) | | | |
| | Request | | | | | |
| | StoporPartial | | | | | |
| | StoporAdd | | | | | |
| Registration | M | | ENUMERATED | Type of request for which the resource | YES | reject |
| Request | | | (start | status is required. | | |
| | | | stop, . . . , | | | |
| | | | partial | | | |
| | | | stop, add) | | | |
| Report | O | | BITSTRING | Each position in the bitmap indicates | YES | reject |
| Characteristics | | | (SIZE(32)) | measurement object the eNB₂ is | | |
| | | | | requested to report | | |
| | | | | First Bit = PRB Periodic, | | |
| | | | | Second Bit = TNL load Ind Periodic, | | |
| | | | | Third Bit = HW Load Ind Periodic, | | |
| | | | | Fourth Bit = Composite Available | | |
| | | | | Capacity Periodic, this bit should be | | |
| | | | | set to 1 if at least one of the First, | | |
| | | | | Second or Third bits is set to 1, | | |
| | | | | Fifth Bit = ABS Status Periodic, | | |
| | | | | Sixth Bit = RSRP Measurement Report | | |
| | | | | Periodic, | | |
| | | | | Seventh Bit = CSI Report Periodic, | | |
| | | | | Eight Bit = Neighbour Cell CAC | | |
| | | | | Reporting based on condition. | | |
| | | | | Other bits shall be ignored by the | | |
| | | | | eNB₂. | | |
| | | | | [symbol] | | |
| Cell To Report | | 1 | | Cell ID list to which the request | YES | ignore |
| | | | | applies. | | |
| >Cell To | | 1 . . . | | | EACH | ignore |
| Report Item | | <max | | | | |
| | | CellineNB> | | | | |
| >>Cell ID | M | | ECGI | | — | |
| | | | 9.2.14 | | | |
| Reporting | O | | ENUMERATED | Periodicity that can be used for | YES | ignore |
| Periodicity | | | (1000 ms, | reporting of PRB Periodic, TNL Load | | |
| | | | 2000 ms, | Ind Periodic, HW Load Ind Periodic, | | |
| | | | 5000 ms, 10000 | Composite Available Capacity Periodic | | |
| | | | ms, . . . ) | or ABS Status Periodic. | | |
| Partial Success | O | | ENUMERATED | Included if partial success is allowed | YES | ignore |
| Indicator | | | (partial | | | |
| | | | success | | | |
| | | | allowed, . . . ) | | | |
| Reporting | O | | ENUMERATED | Periodicity that can be used for the | YES | ignore |
| Periodicity of | | | (120 ms, | reporting of RSRP Measurement | | |
| RSRP | | | 240 ms, | Report Periodic. | | |
| Measurement | | | 480 ms, | | | |
| Report | | | 640 ms, . . . ) | | | |
| Reporting | O | | ENUMERATED | Periodicity that can be used for the | YES | ignore |
| Periodicity of | | | (5 ms, | reporting of CSI Report Periodic. | | |
| CSI Report | | | 10 ms, 20 ms, | | | |
| | | | 40 ms | | | |
| | | | 80 ms, . . . ) | | | |
| Neighbour | O | | BOOLEAN | | - | |
| Cells Reporting | | | | | | |
| Conditions | | | | | | |
| > CHOICE E- | | | | | | |
| UTRA | | | | | | |
| >> Neighbour | | 0 . . . | | | | |
| E-UTRA Cell | | <max | | | | |
| List | | CellineNB> | | | | |
| >>> | | | BIT STRING | The leftmost bits of the Neighbour E- | | |
| Neighbour E- | | | (28) | UTRAN Cell Identifier IE value | | |
| UTRA Cell | | | | correspond to the value of the eNB ID | | |
| Identifier | | | | IE contained in the Global eNB ID IE | | |
| | | | | (defined in section 9.2.22) identifying | | |
| | | | | the eNB that controis the cell. | | |
| >> Minimum | M | | INTEGER | Indicate minimum Composite Available | - | |
| Composite | | | (0 . . . 100) | Capacity Downlink of neighbour E- | | |
| Available | | | | UTRA cells. | | |
| Capacity | | | | | | |
| Downlink | | | | | | |
| >>>Minimum | M | | INTEGER | Indicate minimum Composite Available | - | |
| Composite | | | (0 . . . 100) | Capacity Uplink of neighbour E-UTRA | | |
| Available | | | | cells. | | |
| Capacity Uplink | | | | | | |
| > CHOICE NR | | | | | | |
| [symbol] | | | | | | |
| >> Neighbour | | 0 . . . | | | | |
| NR Cell List | | <max | | | | |
| | | Cellinen- | | | | |
| | | gNB> | | | | |
| >>> Neighbour | | | BIT STRING | The leftmost bits of the Neighbour NR | | |
| NR Cell Identity | | | (36) | Cell Identity IE value correspond to the | | |
| | | | | value of the en-gNB ID IE contained in | | |
| | | | | the Global en gNB ID IE (defined in | | |
| | | | | section 9.2.112) identifying the en-gNB | | |
| | | | | that controls the cell. | | |
| >> Minimum | M | | INTEGER | Indicate minimum Composite Available | - | |
| Composite | | | (0 . . . 100) | Capacity Downlink of neighbour NR | | |
| Available | | | | cells. | | |
| Capacity | | | | | | |
| Downlink | | | | | | |
| >>>Minimum | M | | INTEGER | Indicate minimum Composite Available | - | |
| Composite | | | (0 . . . 100) | Capacity Uplink of neighbour NR cells. | | |
| Available | | | | | | |
| Capacity Uplink | | | | | | |

| Range bound | Explanation |
|---|---|
| maxCelineNB | Maximum no. cells that can be served by an eNB. Value is 256. |
| Condition | Explanation |
| ifRegistration RequestStopor | This IE shall be present if the Registration Request IE is set to the |
| PartialStoporAdd | value “stop”, “partial stop” or “add”. |

[symbol]

indicates data missing or illegible when filed

### Resource Status Update

This message is sent by eNB2 to neighbouring eNB1 to report the results of the requested measurements.
Direction: eNB2→eNB1.

In some of these embodiments, the eNB1 may be the first network node 111, and the eNB2 may be the second network node 112.

| | | | IE type and | Semantics | Criticality | Assigned |
|---|---|---|---|---|---|---|
| IE/Group Name | Presence | Range | reference | description | | Criticality |
| Message Type | M | | 9.2.13 | | YES | ignore |
| eNB1 Measurement ID | M | | INTEGER | Allocated by | YES | reject |
| | | | (1 . . . 4095, . . . ) | eNB₁ | | |
| eNB2 Measurement ID | M | | INTEGER | Allocated by | YES | reject |
| | | | (1 . . . 4095, . . . ) | eNB₂ | | |
| Cell Measurement Result | | 1 | | | YES | ignore |
| >Cell Measurement Result | | 1 . . . < maxCellineNB> | | | EACH | ignore |
| Item | | | | | | |
| >>Cell ID | M | | ECGI | | | |
| | | | 9.2.14 | | | |
| >>Hardware Load Indicator | O | | 9.2.34 | | | |
| >>S1 TNL Load Indicator | O | | 9.2.35 | | | |
| >>Radio Resource Status | O | | 9.2.37 | | | |
| >>Composite Available | O | | 9.2.44 | | YES | ignore |
| Capacity Group | | | | | | |
| >>ABS Status | O | | 9.2.58 | | YES | ignore |
| >>RSRP Measurement Report | O | | 9.2.76 | | YES | ignore |
| List | | | | | | |
| [symbol] | [symbol] | [symbol] | [symbol] | [symbol] | [symbol] | [symbol] |
| >>CSI Report | O | | 9.2.79 | | YES | ignore |
| >>Cell Reporting Indicator | O | | ENUMERATED | | YES | ignore |
| | | | (stop | | | |
| | | | request, . . . ) | | | |
| >> Resource Aggregation List | O | | | | | |
| >>> CHOICE E-UTRA | | | | | | |
| >>>>E-UTRA Cell List | | 1 . . . < maxCellineNB> | | | | |
| >>>>> E-UTRA Cell Identifier | | | BIT STRING | | | |
| | | | (28) | | | |
| >>> CHOICE NR | | | | | | |
| >>>> NR Cell List | | 1 . . . < maxCellinen-gNB> | | | | |
| >>>>> NR Cell Identity | | | BIT STRING | | | |
| | | | (36) | | | |
| >>>>> Composite Available | O | | 9.2.44 | | YES | ignore |
| Capacity Group | | | | | | |

[symbol]

indicates data missing or illegible when filed

### EN-DC Resource Status Request

This message is sent by the eNB to the en-gNB or by the en-gNB to the eNB to initiate the requested measurement according to the parameters given in the message.
Direction: E-UTRAN node1→E-UTRAN node2 (eNB→en-gNB, en-gNB→eNB).

In some of these embodiments, any of the transmitting nodes, e.g. the E-UTRAN node1, the eNB, and/or the en-gNB may be the first network node 111, and any of the receiving nodes, e.g. the E-UTRAN node2, the eNB, and/or the en-gNB may be the second network node 112.

| | | | IE type and | | | Assigned |
|---|---|---|---|---|---|---|
| IE/Group Name | Presence | Range | reference | Semantics description | Criticality | Criticality |
| Message Type | M | | 9.2.3.1 | | YES | reject |
| E-UTRAN node1 | M | | INTEGER | Allocated by the E-UTRAN node₁. | YES | reject |
| Measurement ID | | | (1 . . . 4095, . . . ) | | | |
| E-UTRAN node2 | C-ifRegistration | | INTEGER | Allocated by the E-UTRAN node₂. | YES | ignore |
| Measurement ID | Request | | (1 . . . 4095, . . . ) | | | |
| | StoporAdd | | | | | |
| Registration | M | | ENUMERATED | Type of request for which the resource status is | YES | reject |
| Request EN-DC | | | (start, | required. | | |
| | | | stop, add, | | | |
| | | | . . . ) | | | |
| Reporting | O | | ENUMERAT | Periodicity that can be used for reporting of PRB | YES | ignore |
| Periodicity EN-DC | | | ED (500 ms, | Periodic, TNL Capacity Ind Periodic, Composite | | |
| | | | 1000 ms, | Available Capacity Periodic. | | |
| | | | 2000 ms, | Also used as the averaging window length for all | | |
| | | | 5000 ms, 10000 | measurement object if supported. | | |
| | | | ms, . . . ) | | | |
| [symbol] | [symbol] | [symbol] | [symbol] | [symbol] | [symbol] | [symbol] |
| Report | C- | | BITSTRING | When sent by the eNB, each position in the bitmap | YES | ignore |
| Characteristics | ifRegistration | | (SIZE(32) | indicates measurement object the en-gNB is | | |
| EN-DC | Request | | | requested to report. | | |
| | Start | | | First Bit = PRB Periodic, | | |
| | | | | Second Bit = TNL Capacity Ind Periodic, | | |
| | | | | Third Bit = | | |
| | | | | Composite Available Capacity Periodic, Fourth Bit = | | |
| | | | | Number of Active UEs. | | |
| | | | | Other bits shall be ignored by the en-gNB. | | |
| | | | | When sent by the en-gNB, each position in the bitmap | | |
| | | | | indicates measurement object the eNB is requested to | | |
| | | | | report. | | |
| | | | | First Bit = PRB Periodic, | | |
| | | | | Second Bit = TNL load Ind Periodic, | | |
| | | | | Third Bit = HW Load Ind Periodic, | | |
| | | | | Fourth Bit = Composite Available Capacity Periodic, | | |
| | | | | this bit should be set to 1 if at least one of the First, | | |
| | | | | Second or Third bits is set to 1, | | |
| | | | | Fifth Bit = Neighbour Cell CAC Reporting based on | | |
| | | | | condition. | | |
| | | | | Other bits shall be ignored by the eNB. | | |
| NR Cell To | | 0 . . . 1 | | NR cell ID list to which the request applies. | YES | ignore |
| Report EN-DC | | | | | | |
| List | | | | | | |
| >NR Cell To | | 1 . . . | | | EACH | ignore |
| Report EN-DC | | <maxC | | | | |
| Item | | ellineng | | | | |
| | | NB> | | | | |
| >>NR Cell ID | M | | NR CGI | | — | |
| | | | 9.2.111 | | | |
| [symbol] | [symbol] | [symbol] | [symbol] | [symbol] | [symbol] | [symbol] |
| >>SSB To | | 0 . . . 1 | | SSB list to which the request applies. | YES | ignore |
| Report List | | | | | | |
| >>>>SSB To | | 1 . . . | | | EACH | ignore |
| Report Item | | <maxno | | | | |
| | | ofSSBA | | | | |
| | | reas> | | | | |
| >>>>SSB | M | | 9.2.167 | | — | |
| Index | | | | | | |
| Interface Instance | O | | 9.2.143 | | YES | reject |
| Indication | | | | | | |
| E-UTRA Cell To | | 0 . . . 1 | | E-UTRA cell ID list to which the request applies. | YES | ignore |
| Report EN-DC | | | | | | |
| List | | | | | | |
| >E-UTRA Cell | | 1 . . . | | \| | EACH | ignore |
| To Report EN- | | <maxC | | | | |

| | | | | | |
|---|---|---|---|---|---|
| DC Item | | ellineNB | | | |
| | | > | | | |
| >>E-UTRA | M | | ECGI | | — |
| Cell ID | | | 9.2.14 | | |
| Cells for | O | | BOOLEAN | | - |
| Resource | | | | | |
| Aggregation | | | | | |
| > CHOICE E- | | | | | |
| UTRA | | | | | |
| >> Minimum | M | | INTEGER | Indicate minimum Composite Available Capacity | - |
| Composite | | | (0 . . . 100) | Downlink of candidate E-UTRA cells for resource | |
| Available Capacity | | | | aggregation. | |
| Downlink | | | | | |
| >> Minimum | M | | INTEGER | Indicate minimum Composite Available Capacity | - |
| Composite | | | (0 . . . 100) | Uplink of candidate E-UTRA cells for resource | |
| Available Capacity | | | | aggregation | |
| Uplink | | | | | |
| > CHOICE NR | | | | | |
| >> Minimum | M | | INTEGER | Indicate minimum Composite Available Capacity | - |
| Composite | | | (0 . . . 100) | Downlink of candidate NR cells for resource | |
| Available Capacity | | | | aggregation. | |
| Downlink | | | | | |
| >> Minimum | M | | INTEGER | Indicate minimum Composite Available Capacity | - |
| Composite | | | (0 . . . 100) | Uplink of candidate NR cells for resource aggregation. | |
| Available Capacity | | | | | |
| Uplink | | | | | |

[symbol]

indicates data missing or illegible when filed

### EN-DC Resource Status Update

This message is sent by the en-gNB or by the eNB to the en-gNB to the eNB to report the results of the requested measurements.
Direction: E-UTRAN node2→E-UTRAN node1 (en-gNB→eNB, eNB→en-gNB).

In some of these embodiments, any of the transmitting nodes, e.g. the E-UTRAN node2, the eNB, and/or the en-gNB may be the second network node 112, and any of the receiving nodes, e.g. the E-UTRAN node1, the eNB, and/or the en-gNB may be the first network node 111.

| | | | IE type and | | | Assigned |
|---|---|---|---|---|---|---|
| IE/Group Name | Presence | Range | reference | Semantics description | Criticality | Criticality |
| Message Type | M | | 9.2.3.1 | | YES | ignore |
| E-UTRAN node1 Measurement ID | M | | INTEGER | Allocated by the E-UTRAN node₁. | YES | reject |
| | | | (1 . . . 4095, . . . ) | | | |
| E-UTRAN node2 Measurement ID | M | | INTEGER | Allocated by the E-UTRAN node₂. | YES | reject |
| | | | (1 . . . 4095, . . . ] | | | |
| NR Cell Measurement Result | | 0 . . . 1 | | Concerned NR cells in the en- | YES | ignore |
| | | | | gNB. | | |
| >NR Cell Measurement Result | | 1 . . . | | | EACH | ignore |
| Item | | <maxCe | | | | |
| | | llinengN | | | | |
| | | B> | | | | |
| >>NR Cell ID | M | | NR CGI | | — | |
| | | | 9.2.111 | | | |
| >>NR Radio Resource Status | O | | 9.2.162 | | — | |
| >>TNL Capacity Indicator | O | | 9.2.161 | | — | |
| >>NR Composite Available | O | | 9.2.163 | | — | |
| Capacity Group | | | | | | |
| >>Number of Active UEs | O | | INTEGER | As defined in TS 38.314 [45]. | — | |
| | | | (0 . . . 16777215, | Value “1” is equivalent to 0.1 | | |
| | | | . . . ) | Active UEs, value “2” is | | |
| | | | | equivalent to 0.2 Active UEs, | | |
| | | | | value n is equivalent to n/10 | | |
| | | | | Active UEs. | | |
| [symbol] | [symbol] | [symbol] | [symbol] | [symbol] | [symbol] | [symbol] |
| | | | | [symbol] | | |
| Interface Instance Indication | O | | 9.2.143 | | YES | reject |
| E-UTRA Cell Measurement Result | | 0 . . . 1 | | Concerned E-UTRA cells in the | YES | ignore |
| | | | | eNB. | | |
| >E-UTRA Cell Measurement | | 1 . . . | | | EACH | ignore |
| Result Item | | <maxCe | | | | |
| | | llineNB> | | | | |
| >>E-UTRA Cell ID | M | | ECGI | | — | |
| | | | 9.2.14 | | | |
| >>Hardware Load Indicator | O | | 9.2.34 | | — | |
| >>S1 TNL Load Indicator | O | | 9.2.35 | | — | |
| >>Radio Resource Status | O | | 9.2.37 | | — | |
| >>Composite Available Capacity | O | | 9.2.44 | | — | |
| Group | | | | | | |
| Resource Aggregation List | \|O | | | | | |
| > CHOICE E-UTRA | | | | | | |
| >> E-UTRA Cell List | | 1 . . . | | | | |
| | | <maxCe | | | | |
| | | llineNB> | | | | |
| >>> E-UTRA Cell Identifier | | | BIT STRING | The leftmost bits of the E-UTRAN | | |
| | | | (28) | Cell Identifier IE value correspond | | |
| | | | | to the value of the eNB ID IE | | |
| | | | | contained in the Global eNB ID IE | | |
| | | | | defined in section 9.2.22) | | |
| | | | | identifying the eNB that controls | | |
| | | | | the cell. | | |
| [symbol] | | | | [symbol] | | |
| > CHOICE NR | | | | | | |
| >> NR Cell List | | 1 . . . | | | | |
| | | <maxCe | | | | |
| | | llinen- | | | | |
| | | gNB> | | | | |
| >>> NR Cell Identity | | | BIT STRING | The leftmost bits of the NR Cell | | |
| | | | (36) | Identity IE value correspond to | | |
| | | | | the value of the en-gNB ID IE | | |
| | | | | contained in the Global en-gNB | | |
| | | | | ID IE (defined in section 9.2.112) | | |
| | | | | identifying the en-gNB that | | |
| | | | | controls the cell. | | |

[symbol]

indicates data missing or illegible when filed

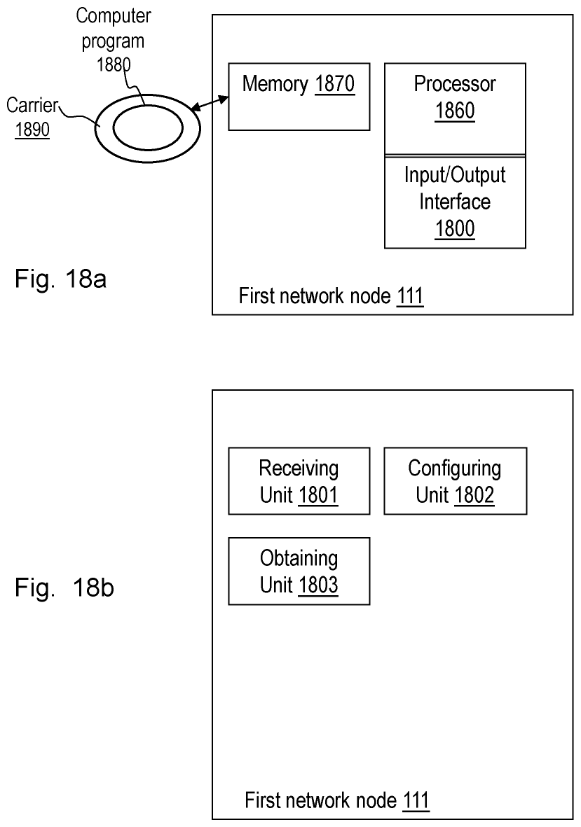

FIGS. 18a and 18b show examples of an arrangement in the first network node 111.

The first network node 111 may comprise an input and output interface 1800 configured to communicate e.g. with any of the networking entities operating in the wireless communications network 100 of embodiments herein such as e.g. the second network node 112 and/or the UE 120. The input and output interface may comprise a receiver, e.g. wired and/or wireless, (not shown) and a transmitter, e.g. wired and/or wireless, (not shown).

The first network node 111 may comprise any one or more out of: a receiving unit, 1801 a configuring unit 1802, and an obtaining unit 1803 to perform the method actions as described herein, e.g. actions 901-905 above.

The second network node 111 may be configured to perform Embodiments 1-5, and 15-19 as described below, e.g., by use of any one or more of the above-mentioned units. Furthermore, the second network node 111 may be configured to perform the following features, e.g., by use of any one or more of the above-mentioned units.

In some embodiments, the one or more conditions triggers the second network node 112 to provide the status information associated with the third network node 113, only when the at least one of the one or more conditions is fulfilled.

In some embodiments, the one or more conditions are associated with operations of the third network node 113 and the second network node 112, or associated with the third network node 113 only.

In some embodiments, the one or more conditions are provided by the first network node 111 to the second network node 112 for triggering the reporting of status information associated with the third network node 113 and is based on any one or more out of:
one or more measurements or predictions of capacity or status information associated with the third network node 113 and/or the second network node 112,
one or more measurements and/or predictions of coverage information associated with the third network node 113 and/or the second network node 112,
one or more measurements or predictions of one or more traffic type or traffic load information associated with the third network node 113 and/or the second network node 112, and
a combination thereof.

In some embodiments, the first request message indicates to the second network node 112 any one or more out of:
an identifier of at least the third network node 113 for which conditions are provided for reporting status information to the first network node 111,
an identifier of at least a radio cell associated with at least the third network node 113 for which conditions are provided for reporting status information to the first network node 111,
an identifier of the coverage area of at least one Synchronization Signal Block, SSB, beam of a group of SSB beams associated with at least the third network node 113 for which conditions are provided for reporting status information to the first network node 111,
an identifier of at least a network slice or a group of network slices associated with at least the third network node 113 for which conditions are provided for reporting status information to the first network node 111, and
a combination thereof.

In some embodiments, the one or more conditions are based on one or more measurements or predictions of at least one capacity metric at the third network node 113, wherein the at least one capacity metric are any of a Composite Available Capacity, CAC, a capacity value, a transport network capacity metric, or a combination thereof, and wherein the one or more conditions relating to available capacity is expressed per cell of the third network node 113, per SSB beam or group of SSB beam coverage area at the third network node 113, per network slice or group of network slices, or combinations thereof.

In some embodiments, the one or more conditions are based on one or more measurements or predictions of resource status utilization or resource status availability at the third network node 113, and wherein the one or more conditions relating to resource status utilization or resource status availability is expressed per cell of the third network node 113, per SSB beam or group of SSB beam coverage area at the third network node 113, per network slice or group of network slices, or combinations thereof.

In some embodiments, the one or more conditions are based on measurements or predictions of one or more types of number of user devices present in a coverage area of radio cells, per coverage area of individual SSB beams or groups thereof, per network slice or group of network slices of the third network node 113, or a combination thereof.

In some embodiments, the one or more conditions comprises conditions relating to a combination of conditions at the third network node 113, the combination of conditions relating to metrics of any one or more out of: capacity, resource status utilization, resource status availability, types or number of user devices, hardware load, hardware capacity.

In some embodiments, at least one of the one or more conditions are based on measurements or predictions of hardware load or hardware capacity at the third network node 113.

In some embodiments, the status information associated with the third network node 113 comprises any one or more out of: capacity information, load information, resource status utilization information, and hardware utilization associated with the third network node 112.

The embodiments herein may be implemented through one or more processors, such as at least one processor 1860 of a processing circuitry in the first network node 111 depicted in FIG. 18a, together with computer program code for performing the functions and actions of the embodiments herein. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 1870 comprising one or more memory units. The memory comprises instructions executable by the at least one processor in the first network node 111. The memory is arranged to be used to store instructions, data, configurations, measurements, COT parameters, and applications to perform the methods herein when being executed in the first network node 111.

In some embodiments the first network node 111 may further comprise a computer program 1880 comprising instructions, which when executed by the at least one processor, cause the at least one processor of the first network node 111 to perform the actions above.

In some embodiments, a carrier 1890 comprises the computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the first network node 111, described below may refer to a combination of analog and digital circuits, and/or one or more processors configured with software and/or firmware, e.g. stored in the first network node 111, that when executed by the at least one processor described above cause the one or more processors to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

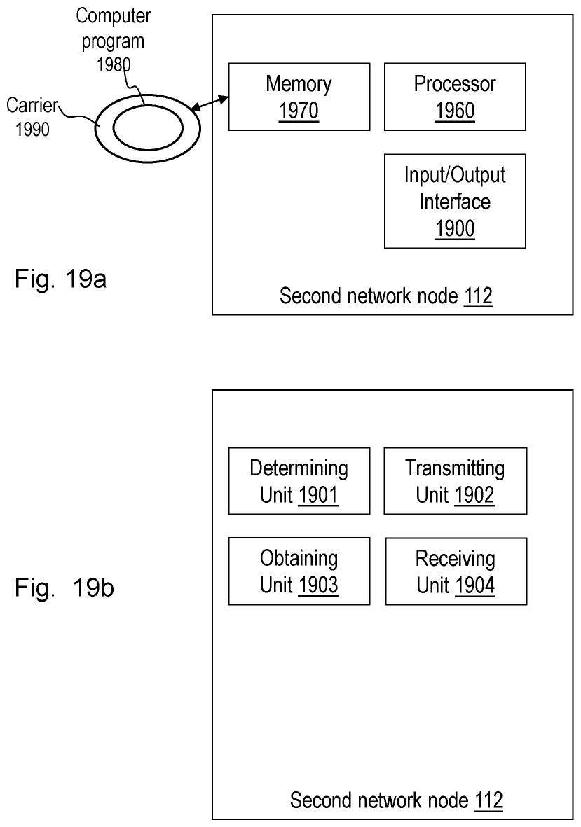

FIGS. 19a and 19b show examples of an arrangement in the second network node 112.

The second network node 112 may comprise an input and output interface 1900 configured to communicate e.g. with any of the networking entities operating in the wireless communications network 100 of embodiments herein such as e.g. the first network node 111, the third network node 113, and/or the UE 120. The input and output interface may comprise a receiver, e.g. wired and/or wireless, (not shown) and a transmitter, e.g. wired and/or wireless, (not shown).

The second network node 112 may comprise any one or more out of: a receiving unit 1904, a determining unit 1901, a transmitting unit 1902, and an obtaining unit 1903 to perform the method actions as described herein, e.g. actions 1001-1006 above. The second network node 112 may be configured to perform Embodiments 8-12, and 20-24 as described below, e.g., by use of any one or more of the above-mentioned units. Furthermore, the second network node 112 may be configured to perform the following features, e.g., by use of any one or more of the above-mentioned units.

In some embodiments, the one or more conditions are adapted to trigger the second network node 112 to provide the status information associated with the third network node 113, only when the at least one of the one or more conditions is fulfilled.

In some embodiments, the one or more conditions are associated with operations of the third network node 113 and the second network node 112, or associated with the third network node 113 only.

In some embodiments, the one or more conditions are provided by the first network node 111 to the second network node 112 for triggering the reporting of status information associated with the third network node 113 and is based on any one or more out of:
one or more measurements or predictions of capacity or status information associated with the third network node 113 and/or the second network node 112,
one or more measurements and/or predictions of coverage information associated with the third network node 113 and/or the second network node 112,
one or more measurements or predictions of one or more traffic type or traffic load information associated with the third network node 113 and/or the second network node 112, and
a combination thereof.

In some embodiments, the first request message indicates to the second network node 112 any one or more out of:
an identifier of at least the third network node 113 for which conditions are provided for reporting status information to the first network node 111,
an identifier of at least a radio cell associated with at least the third network node 113 for which conditions are provided for reporting status information to the first network node 111,
an identifier of the coverage area of at least one Synchronization Signal Block, SSB, beam of a group of SSB beams associated with at least the third network node 113 for which conditions are provided for reporting status information to the first network node 111,
an identifier of at least a network slice or a group of network slices associated with at least the third network node 113 for which conditions are provided for reporting status information to the first network node 111, and
a combination thereof.

In some embodiments, the one or more conditions are based on one or more measurements or predictions of at least one capacity metric at the third network node 113, wherein the at least one capacity metric are any of a Composite Available Capacity, CAC, a capacity value, a transport network capacity metric, or a combination thereof, and wherein the one or more conditions relating to available capacity is expressed per cell of the third network node 113, per SSB beam or group of SSB beam coverage area at the third network node 113, per network slice or group of network slices, or combinations thereof.

In some embodiments, the one or more conditions are based on one or more measurements or predictions of resource status utilization or resource status availability at the third network node 113, and wherein the one or more conditions relating to resource status utilization or resource status availability is expressed per cell of the third network node 113, per SSB beam or group of SSB beam coverage area at the third network node 113, per network slice or group of network slices, or combinations thereof.

In some embodiments, the one or more conditions are based on measurements or predictions of one or more types of number of user devices present in a coverage area of radio cells, per coverage area of individual SSB beams or groups thereof, per network slice or group of network slices of the third network node 113, or a combination thereof.

In some embodiments, the one or more conditions comprises conditions relating to a combination of conditions at the third network node 113, the combination of conditions relating to metrics of any one or more out of: capacity, resource status utilization, resource status availability, types or number of user devices, hardware load, hardware capacity.

In some embodiments, at least one of the one or more conditions are based on measurements or predictions of hardware load or hardware capacity at the third network node 113.

In some embodiments, the status information associated with the third network node 113 comprises any one or more out of: capacity information, load information, resource status utilization information, and hardware utilization associated with the third network node 112.

The embodiments herein may be implemented through one or more processors, such as at least one processor 1960 of a processing circuitry in the second network node 112 depicted in FIG. 19a, together with computer program code for performing the functions and actions of the embodiments herein. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The second network node 112 may further comprise a memory 1970 comprising one or more memory units. The memory comprises instructions executable by the at least one processor in the second network node 112. The memory is arranged to be used to store instructions, data, configurations, measurements, COT parameters, and applications to perform the methods herein when being executed in the second network node 112.

In some embodiments the second network node 112 may further comprise a computer program 1980 comprising instructions, which when executed by the at least one processor, cause the at least one processor of the second network node 112 to perform the actions above.

In some embodiments, a carrier 1990 comprises the computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the second network node 112, described below may refer to a combination of analog and digital circuits, and/or one or more processors configured with software and/or firmware, e.g. stored in the second network node 112, that when executed by the at least one processor described above cause the one or more processors to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein are not limited to the above described preferred embodiments. Various alternatives, modifications and equivalents may be used.

Below, some example embodiments 1-24 are shortly described. See e.g. FIGS. 8, 9, 10, 11, 12, 13, 14, 15, 16, 17, 18a, 18b, 19a, and 19b.

Embodiment 1. A method performed by a first network node 111, e.g. for configuring, e.g. requesting, a second network node 112 to provide status information, e.g. load information, associated with a third network node 113 in a wireless communications network 100, the method e.g. comprising any one or more out of:
e.g. configuring 903, e.g. requesting, the second network node 112 e.g. by transmitting a first request message to the second network node 112, wherein the first request message is indicative of one or more conditions for triggering the second network node 112 to provide status information, e.g. load information, associated with the third network node 113, only when at least one of the one or more conditions is fulfilled,
receiving 904, 905 a message from the second network node 112 e.g. indicative of any one out of:
904 e.g. in a first response message, a successful or partially successful initialization of a configuration procedure, e.g. conditional forwarding configuration procedure, e.g. based on that the at least one of the one or more conditions is fulfilled, or
905 e.g. in an update message, a status information, e.g. load information, associated with the third network node 113, e.g. based on that the at least one of the one or more conditions is fulfilled, or
904 e.g. in a first response message, an unsuccessful or failure to initialize the configuration procedure, e.g. conditional forwarding configuration procedure, e.g. based on that the at least one of the one or more conditions is not fulfilled.

Embodiment 2. The method according to Embodiment 1, e.g. wherein each respective condition out of the one or more conditions relates to a condition to be fulfilled by the third network node 113, and wherein any one or more out of the one or more conditions relates to any one or more out of:
one or more cell types, e.g. Primary Secondary Cell Group Cell, PSCell,
one or more network node types,
one or more identifiers, e.g. index/indices, e.g. of a beam, e.g. SSB beam, e.g. of a cell, e.g. of a network node, e.g. of a coverage area, e.g. of a network slice, e.g. of a group of network nodes, e.g. of a group of SSB beams,
one or more identifier of one or more coverage areas,
measurements and/or predictions of any one or more out of load information, coverage information, and/or traffic load information,
resource status utilization and/or resource status availability,
e.g. measurements and/or predictions of, hardware load and/or hardware capacity,
Guaranteed Bit Rate, GBR, and/or non-GBR Physical Resource Block usage in Uplink and/or in Downlink e.g. of at least one cell,
Physical Downlink Control Channel, PDCCH, Control Channel Element, CCE scheduling in Uplink and/or in Downlink of at least one cell,
UE status, e.g. activity and/or capability of one or more UEs, and/or a number/quantity of UEs, e.g. within a cell,
any one or more out of resource status utilization, resource status availability, types or number of user devices, hardware load, and/or hardware capacity.

Embodiment 3. The method according to any of Embodiments 1-2, further comprising:
obtaining 902, e.g. determining, the one or more conditions for triggering the second network node 112 to provide status information, e.g. load information, associated with the third network node 113, only when the at least one of the one or more conditions is fulfilled.

Embodiment 4. The method according to any of Embodiments 1-3, further comprising e.g. any one or more out of:
obtaining 901 status information, e.g. load information, of the first network node 111, and
wherein obtaining 902, e.g. determining, the one or more conditions for triggering the second network node 112 to provide status information, e.g. load information, associated with the third network node 113, only when the at least one of the one or more conditions is fulfilled is further based on the obtained status information, e.g. load information, of the first network node 111.

Embodiment 5. The method according to any of Embodiments 1-4, wherein the one or more conditions comprises at least one filtering condition, e.g. wherein the at least one filtering condition indicates, e.g. to the second network node 112, at least some status information, e.g. load information, not to be transmitted e.g. forwarded, to the first network node 111.

Embodiment 6. A computer program comprising instructions, which when executed by a processor, causes the processor to perform actions according to any of the Embodiments 1-5.

Embodiment 7. A carrier comprising the computer program of Embodiment 6, wherein the carrier is one of an electronic signal, an optical signal, an electromagnetic signal, a magnetic signal, an electric signal, a radio signal, a microwave signal, or a computer-readable storage medium.

Embodiment 8. A method performed by a second network node 112, e.g. for configuring, e.g. such as a first network node 111 requesting, the second network node 112 to provide status information, e.g. load information, associated with a third network node 113 to the first network node 111, in a wireless communications network 100, the method e.g. comprising any one or more out of:
receiving 1001 a first request message from the first network node 111, wherein the first request message is indicative of one or more conditions for triggering the second network node 112 to provide status information, e.g. load information, associated with the third network node 113, only when at least one of the one or more conditions is fulfilled,
e.g. optionally determining 1002 the at least one of the one or more conditions to be fulfilled, e.g. for providing status information, e.g. load information, associated with the third network node 113, to the first network node 111,
transmitting 1005, 1006 a message to the first network node 111 e.g. indicative of any one out of:
1005 e.g. in a first response message, a successful or partially successful initialization of a configuration procedure, e.g. conditional forwarding configuration procedure, e.g. based on that the at least one of the one or more conditions is fulfilled, or
1006 e.g. in an update message, a status information, e.g. load information associated with the third network node 113, e.g. based on that the at least one of the one or more conditions is fulfilled, or
1005 e.g. in a first response message, an unsuccessful or failure to initialize the configuration procedure, e.g. conditional forwarding configuration procedure, e.g. based on that the at least one of the one or more conditions is not fulfilled.

Embodiment 9. The method according to Embodiment 8, e.g. wherein each respective condition out of the one or more conditions relates to a condition to be fulfilled by the third network node 113, and wherein any one or more out of the one or more conditions relates to any one or more out of:
one or more cell types, e.g. Primary Secondary Cell Group Cell, PSCell,
one or more network node types,
one or more identifiers, e.g. index/indices, e.g. of a beam, e.g. SSB beam, e.g. of a cell, e.g. of a network node, e.g. of a coverage area, e.g. of a network slice, e.g. of a group of network nodes, e.g. of a group of SSB beams,
one or more identifier of one or more coverage areas,
measurements and/or predictions of any one or more out of load information, coverage information, and/or traffic load information,
resource status utilization and/or resource status availability,
e.g. measurements and/or predictions of, hardware load and/or hardware capacity,
Guaranteed Bit Rate, GBR, and/or non-GBR Physical Resource Block usage in Uplink and/or in Downlink e.g. of at least one cell,
Physical Downlink Control Channel, PDCCH, Control Channel Element, CCE scheduling in Uplink and/or in Downlink of at least one cell,
UE status, e.g. activity and/or capability of one or more UEs, and/or a number/quantity of UEs, e.g. within a cell,
any one or more out of resource status utilization, resource status availability, types or number of user devices, hardware load, and/or hardware capacity.

Embodiment 10. The method according to any of Embodiments 8-9, further comprising:
e.g. obtaining 1004 the status information, e.g. load information, associated with the third network node 113, from the third network node 113, e.g. wherein obtaining 1004 the status information, e.g. load information, is performed by requesting and receiving the status information, e.g. triggered by and/or based on the first request message, and
wherein transmitting 1006 the update message comprises the obtained load information associated with the third network node 113.

Embodiment 11. The method according to any of Embodiments 8-10, further comprising any one or more out of:
determining 1003, e.g., verifying, that the at least one of the one or more conditions is fulfilled, and
wherein transmitting 1005, 1006 the message, e.g. the update message, to the first network node 111 is performed based on the whether or not the at least one of the one or more conditions is determined, e.g. verified, to be fulfilled.

Embodiment 12. The method according to any of Embodiments 8-11, wherein the one or more conditions comprises at least one filtering condition, e.g. wherein the at least one filtering condition indicates, e.g. to the second network node 112, at least some status information, e.g. load information, not to be transmitted e.g. forwarded, to the first network node 111, and wherein transmitting 1006 the update message comprises filtering the status information, e.g. load information, based on the filtering condition, before transmitting the update message to the first network node 111.

Embodiment 13. A computer program comprising instructions, which when executed by a processor, causes the processor to perform actions according to any of the Embodiments 8-12.

Embodiment 14. A carrier comprising the computer program of Embodiment 13, wherein the carrier is one of an electronic signal, an optical signal, an electromagnetic signal, a magnetic signal, an electric signal, a radio signal, a microwave signal, or a computer-readable storage medium.

Embodiment 15. A first network node 111 configured to, e.g. configure, e.g. request, a second network node 112 to provide status information, e.g. load information, associated with a third network node 113 in a wireless communications network 100, the first network node 111, e.g. further being configured to any one or more out of:
e.g. configure, e.g., request, e.g. by means of the configuring unit 1802 in the first network node 111, the second network node 112 e.g. by transmitting a first request message to the second network node 112, wherein the first request message is adapted to be indicative of one or more conditions for triggering the second network node 112 to provide status information, e.g. load information, associated with the third network node 113, only when at least one of the one or more conditions is fulfilled,
receive e.g. by means of the receiving unit 1801 in the first network node 111, a message from the second network node 112 e.g. indicative of any one out of:
e.g. in a first response message, a successful or partially successful initialization of a configuration procedure, e.g. conditional forwarding configuration procedure, e.g. based on that the at least one of the one or more conditions is fulfilled, or
e.g. in an update message, a status information, e.g. load information, associated with the third network node 113, e.g. based on that the at least one of the one or more conditions is fulfilled, or
e.g. in a first response message, an unsuccessful or failure to initialize the configuration procedure, e.g. conditional forwarding configuration procedure, e.g. based on that the at least one of the one or more conditions is not fulfilled.

Embodiment 16. The first network node 111 according to Embodiment 15, e.g. wherein each respective condition out of the one or more conditions are adapted to relate to a condition to be fulfilled by the third network node 113, and wherein any one or more out of the one or more conditions are adapted to relate to any one or more out of:
one or more cell types, e.g. Primary Secondary Cell Group Cell, PSCell,
one or more network node types,
one or more identifiers, e.g. index/indices, e.g. of a beam, e.g. SSB beam, e.g. of a cell, e.g. of a network node, e.g. of a coverage area, e.g. of a network slice, e.g. of a group of network nodes, e.g. of a group of SSB beams,
one or more identifier of one or more coverage areas,
measurements and/or predictions of any one or more out of load information, coverage information, and/or traffic load information,
resource status utilization and/or resource status availability,
e.g. measurements and/or predictions of, hardware load and/or hardware capacity,
Guaranteed Bit Rate, GBR, and/or non-GBR Physical Resource Block usage in Uplink and/or in Downlink e.g. of at least one cell,
Physical Downlink Control Channel, PDCCH, Control Channel Element, CCE scheduling in Uplink and/or in Downlink of at least one cell,
UE status, e.g. activity and/or capability of one or more UEs, and/or a number/quantity of UEs, e.g. within a cell,
any one or more out of resource status utilization, resource status availability, types or number of user devices, hardware load, and/or hardware capacity.

Embodiment 17. The first network node 111 according to any of Embodiments 15-16, further being configured to:
obtain, e.g. by means of the obtaining unit 1803 in the first network node 111, e.g. determine, the one or more conditions for triggering the second network node 112 to provide status information, e.g. load information, associated with the third network node 113, only when the at least one of the one or more conditions is fulfilled.

Embodiment 18. The first network node 111 according to any of Embodiments 15-17, further being configured to e.g. any one or more out of:
obtain, e.g. by means of the obtaining unit 1803 in the first network node 111, status information, e.g. load information, of the first network node 111, and
obtain e.g. by means of the obtaining unit 1803 in the first network node 111, e.g. determining, the one or more conditions for triggering the second network node 112 to provide status information, e.g. load information, associated with the third network node 113, only when the at least one of the one or more conditions is fulfilled further based on the obtained status information, e.g. load information, of the first network node 111.

Embodiment 19. The first network node 111 according to any of Embodiments 15-18, wherein the one or more conditions are adapted to comprise at least one filtering condition, e.g. wherein the at least one filtering condition is adapted to indicate, e.g. to the second network node 112, at least some status information, e.g. load information, not to be transmitted e.g. forwarded, to the first network node 111.

Embodiment 20. A second network node 112 configured to, e.g. configure the second network node 112, such as e.g., requested by a first network node 111, to provide status information, e.g. load information, associated with a third network node 113 to the first network node 111, in a wireless communications network 100, the second network node 112 e.g. further being configured to any one or more out of:
receive, e.g. by means of the receiving unit 1904 in the second network node 112, a first request message from the first network node 111, wherein the first request message is indicative of one or more conditions for triggering the second network node 112 to provide status information, e.g. load information, associated with the third network node 113, only when at least one of the one or more conditions is fulfilled,
e.g. optionally determine, e.g. by means of the determining unit 1901 in the second network node 112, the at least one of the one or more conditions to be fulfilled, e.g. for providing status information, e.g. load information, associated with the third network node 113, to the first network node 111,
transmit, e.g. by means of the transmitting unit 1902 in the second network node 112, a message to the first network node 111 e.g. indicative of any one out of:
e.g. in a first response message, a successful or partially successful initialization of a configuration procedure, e.g. conditional forwarding configuration procedure, e.g. based on that the at least one of the one or more conditions is fulfilled, or
e.g. in an update message, a status information, e.g. load information associated with the third network node 113, e.g. based on that the at least one of the one or more conditions is fulfilled, or
e.g. in a first response message, an unsuccessful or failure to initialize the configuration procedure, e.g. conditional forwarding configuration procedure, e.g. based on that the at least one of the one or more conditions is not fulfilled.

Embodiment 21. The second network node 112 according to Embodiment 20, e.g. wherein each respective condition out of the one or more conditions are adapted to relate to a condition to be fulfilled by the third network node 113, and wherein any one or more out of the one or more conditions are adapted to relate to any one or more out of:
one or more cell types, e.g. Primary Secondary Cell Group Cell, PSCell,
one or more network node types,
one or more identifiers, e.g. index/indices, e.g. of a beam, e.g. SSB beam, e.g. of a cell, e.g. of a network node, e.g. of a coverage area, e.g. of a network slice, e.g. of a group of network nodes, e.g. of a group of SSB beams,
one or more identifier of one or more coverage areas,
measurements and/or predictions of any one or more out of load information, coverage information, and/or traffic load information,
resource status utilization and/or resource status availability,
e.g. measurements and/or predictions of, hardware load and/or hardware capacity,
Guaranteed Bit Rate, GBR, and/or non-GBR Physical Resource Block usage in Uplink and/or in Downlink e.g. of at least one cell,
Physical Downlink Control Channel, PDCCH, Control Channel Element, CCE scheduling in Uplink and/or in Downlink of at least one cell,
UE status, e.g. activity and/or capability of one or more UEs, and/or a number/quantity of UEs, e.g. within a cell,
any one or more out of resource status utilization, resource status availability, types or number of user devices, hardware load, and/or hardware capacity.

Embodiment 22. The second network node 112 according to any of Embodiments 20-21, further being configured to:
e.g. obtain, e.g. by means of the obtaining unit 1903 in the second network node 112, the status information, e.g. load information, associated with the third network node 113, from the third network node 113, e.g. by requesting and receiving the status information, e.g. triggered by and/or based on the first request message, and
transmit, e.g. by means of the transmitting unit 1902 in the second network node 112, the update message, wherein the update message is adapted to comprise the obtained load information associated with the third network node 113.

Embodiment 23. The second network node 112 according to any of Embodiments 20-22, further being configured to any one or more out of:
determine, e.g. by means of the determining unit 1901 in the second network node 112, e.g., verify, that the at least one of the one or more conditions is fulfilled, and
wherein transmit, e.g. by means of the transmitting unit 1902 in the second network node 112, the message, e.g. the update message, to the first network node 111 is performed based on the whether or not the at least one of the one or more conditions is determined, e.g. verified, to be fulfilled.

Embodiment 24. The second network node 112 according to any of Embodiments 20-23, wherein the one or more conditions are adapted to comprise at least one filtering condition, e.g. wherein the at least one filtering condition is adapted to indicate, e.g. to the second network node 112, at least some status information, e.g. load information, not to be transmitted e.g. forwarded, to the first network node 111, and wherein the second network node is configured to transmit, e.g. by means of the transmitting unit 1903 in the second network node 112, the update message by filtering the status information, e.g. load information, based on the filtering condition, before transmitting the update message to the first network node 111.

### Further Extensions and Variations

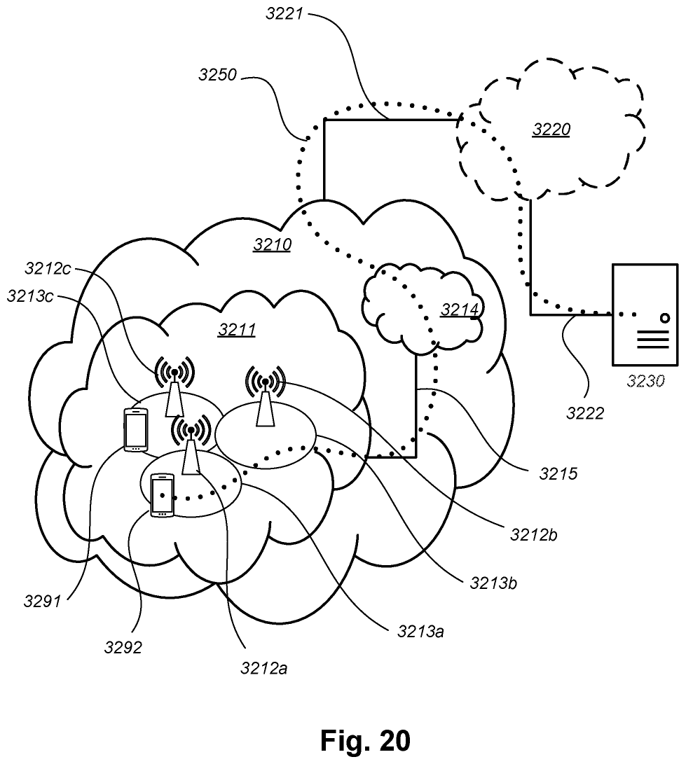

With reference to FIG. 20, in accordance with an embodiment, a communication system includes a telecommunication network 3210 such as the wireless communication network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the first network node 111, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE e.g. the UE 120, such as a Non-AP STA 3291 located in coverage area 3213c is configured to wirelessly connect to, or be paged by, the corresponding base station 3212c. A second UE 3292 e.g. the UE 120, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 20 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

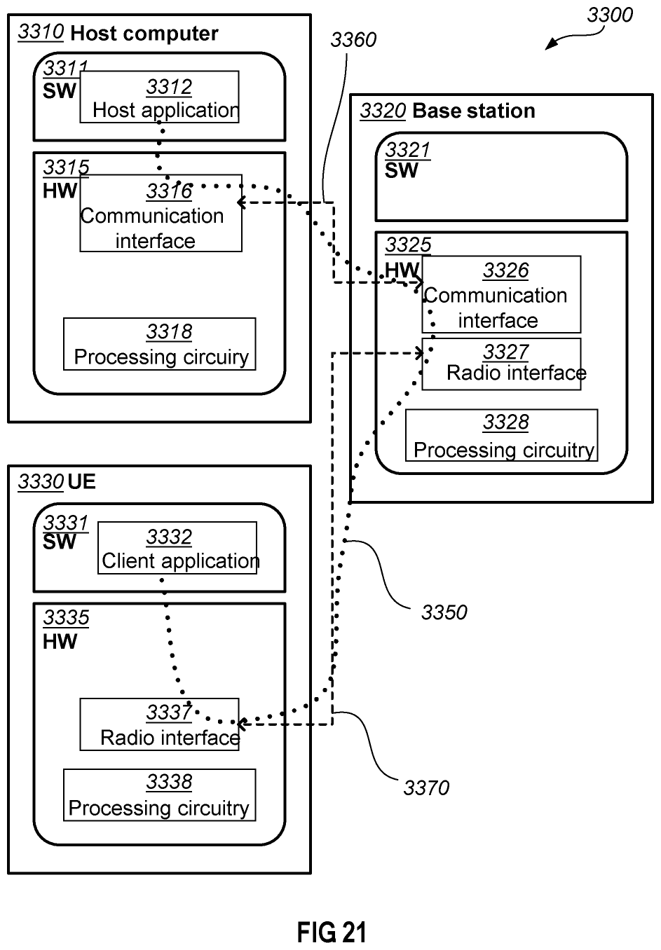

Example implementations, in accordance with an embodiment, of the UE, base station and host computer discussed in the preceding paragraphs will now be described with reference to FIG. 21. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 21) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 21 may be identical to the host computer 3230, one of the base stations 3212a, 3212b, 3212c and one of the UEs 3291, 3292 of FIG. 20, respectively. This is to say, the inner workings of these entities may be as shown in FIG. 21 and independently, the surrounding network topology may be that of FIG. 20.

In FIG. 21, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

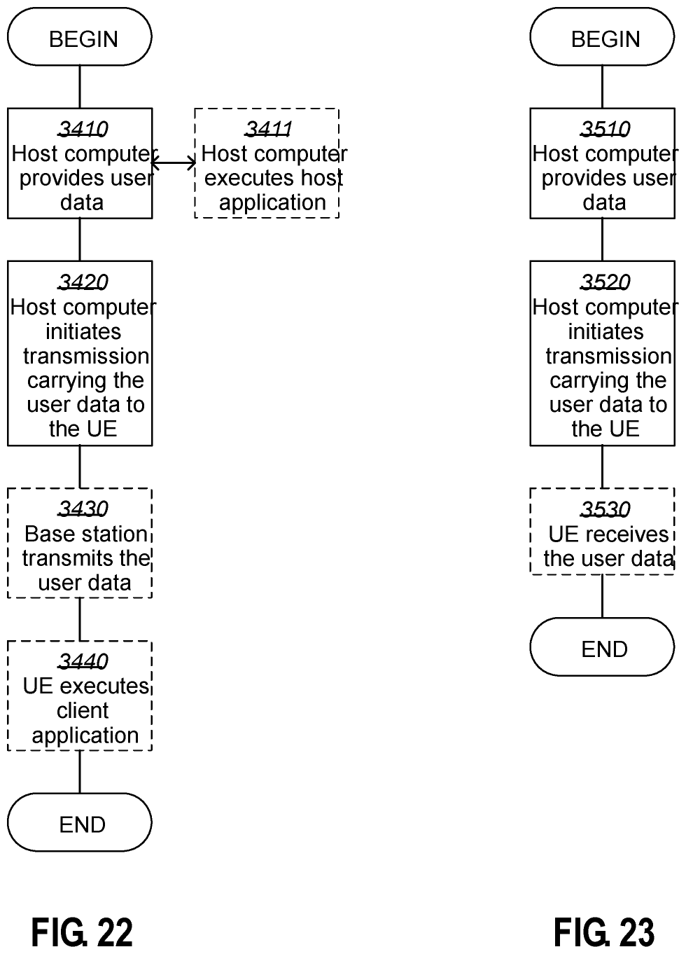

FIG. 22 is a flowchart illustrating a method implemented in a communication system, in accordance with one embodiment. The communication system includes a host computer, a base station such as the first network node 111, and a UE such as the UE 120, which may be those described with reference to FIG. 20 and FIG. 21. For simplicity of the present disclosure, only drawing references to FIG. 22 will be included in this section. In a first action 3410 of the method, the host computer provides user data. In an optional sub action 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 23 is a flowchart illustrating a method implemented in a communication system, in accordance with one embodiment. The communication system includes a host computer, a base station such as an AP STA, and a UE such as a Non-AP STA which may be those described with reference to FIG. 20 and FIG. 21. For simplicity of the present disclosure, only drawing references to FIG. 23 will be included in this section. In a first action 3510 of the method, the host computer provides user data. In an optional sub action (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

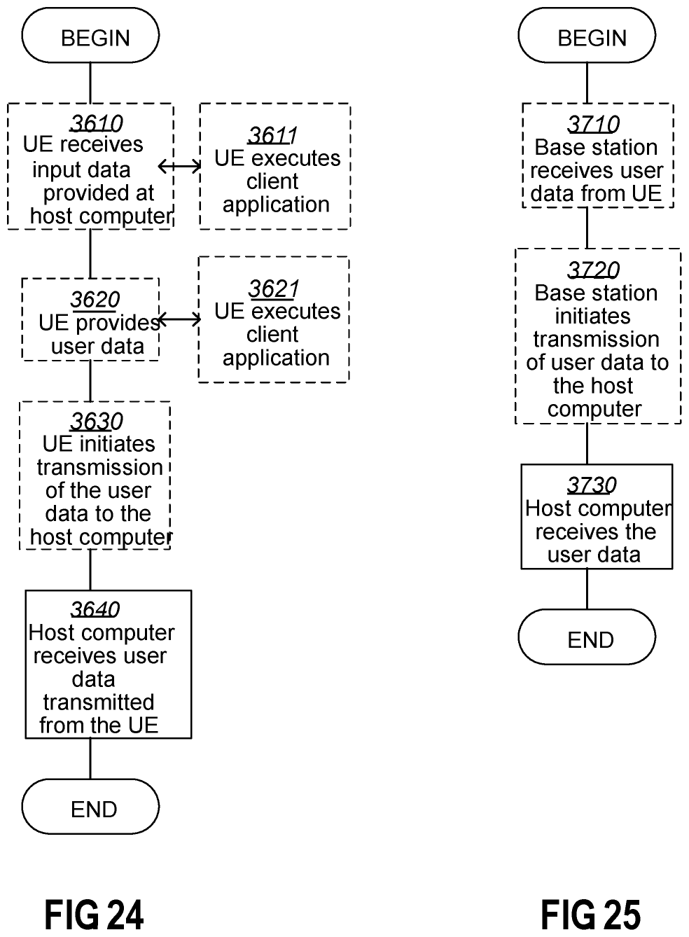

FIG. 24 is a flowchart illustrating a method implemented in a communication system, in accordance with one embodiment. The communication system includes a host computer, a base station such as an AP STA, and a UE such as a Non-AP STA which may be those described with reference to FIG. 20 and FIG. 21. For simplicity of the present disclosure, only drawing references to FIG. 24 will be included in this section. In an optional first action 3610 of the method, the UE receives input data provided by the host computer. Additionally or alternatively, in an optional second action 3620, the UE provides user data. In an optional sub action 3621 of the second action 3620, the UE provides the user data by executing a client application. In a further optional sub action 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub action 3630, transmission of the user data to the host computer. In a fourth action 3640 of the method, the host computer receives the user data transmitted from the UE, in accordance with the teachings of the embodiments described throughout this disclosure.

FIG. 25 is a flowchart illustrating a method implemented in a communication system, in accordance with one embodiment. The communication system includes a host computer, a base station such as an AP STA, and a UE such as a Non-AP STA which may be those described with reference to FIG. 20 and FIG. 21. For simplicity of the present disclosure, only drawing references to FIG. 25 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1.-64. (canceled)

65. A method performed by a first network node for requesting a second network node to provide status information associated with a third network node in a wireless communications network, the method comprising:
requesting the second network node to provide status information by transmitting a first request message to the second network node, wherein the first request message indicates one or more conditions whose fulfillment triggers the second network node to provide status information associated with the third network node; and
receiving a message from the second network node indicative of one of the following:
an at least partially successful initialization of a conditional forwarding configuration procedure;
status information associated with the third network node, based on fulfillment of at least one of the one or more conditions; or
an unsuccessful or failed initialization of the conditional forwarding configuration procedure.

66. The method of claim 65, wherein the one or more conditions include at least one filtering condition that indicates status information not to be transmitted to the first network node.

67. The method of claim 65, wherein each of the one or more conditions is based one or more measurements or predictions of one or more of the following:
capacity or load information associated with the third network node and/or the second network node,
coverage information associated with the third network node and/or the second network node, and
traffic type or traffic load information associated with the third network node and/or the second network node.

68. The method of claim 65, wherein the first request message also includes or indicates one or more of the following:
an identifier of the third network node;
an identifier of at least one radio cell associated with the third network node and to which at least one of the conditions applies;
a coverage area of at least one Synchronization Signal Block (SSB) beam associated with the third network node and to which at least one of the conditions applies,
an identifier of one or more network slices associated with the third network node and to which at least one of the conditions applies.

69. The method of claim 65, wherein:
the one or more conditions are based on one or more measurements or predictions of at least one of the following capacity metrics associated with the third network node: available capacity, Composite Available Capacity (CAC), and transport network capacity; and
each of the one or more conditions relates to a capacity metric for one of the following associated with the third network node: a cell, a Synchronization Signal Block (SSB) beam, a group of SSB beams, a network slice, or a group of network slices.

70. The method of claim 65, wherein:
the one or more conditions are based on one or more measurements or predictions of resource utilization or resource availability at the third network node; and
each of the one or more conditions relates to resource utilization or resource availability for one of the following associated with the third network node: a cell, a Synchronization Signal Block (SSB) beam, a group of SSB beams, a network slice, or a group of network slices.

71. The method of claim 65, wherein:
the one or more conditions are based on one or more measurements or predictions of numbers or types of user devices served by the third network node; and
each of the one or more conditions relates to numbers or types of user devices present in one of the following associated with the third network node: a cell, a Synchronization Signal Block (SSB) beam, a group of SSB beams, a network slice, or a group of network slices.

72. The method of claim 65, wherein the one or more conditions include at least one condition relating to metrics for at least two of the following associated with the third network node: capacity, resource utilization, resource availability, types of user devices, numbers of user devices, hardware utilization, and hardware capacity.

73. The method of claim 65, wherein the status information associated with the third network node comprises one or more of the following: capacity status, load status, resource utilization status, and hardware utilization status.

74. A method performed by a second network node for providing status information associated with a third network node to a first network node in a wireless communications network, the method comprising:
receiving a first request message from the first network node, wherein the first request message indicates one or more conditions whose fulfillment triggers the second network node to provide status information associated with the third network node; and
transmitting a message to the first network node indicative of one of the following:
an at least partially successful initialization of a conditional forwarding configuration procedure;
status information associated with the third network node, based on fulfillment of at least one of the one or more conditions; or
an unsuccessful or failed initialization of the conditional forwarding configuration procedure.

75. The method of claim 74, wherein:
the one or more conditions include at least one filtering condition that indicates status information not to be transmitted to the first network node; and
the method further comprises filtering the status information based on the filtering condition, before transmitting the message indicative of the status information to the first network node.

76. The method of claim 74, wherein each of the one or more conditions is based one or more measurements or predictions of one or more of the following:
capacity or load information associated with the third network node and/or the second network node,
coverage information associated with the third network node and/or the second network node, and
traffic type or traffic load information associated with the third network node and/or the second network node.

77. The method of claim 74, wherein the first request message also includes or indicates one or more of the following:
an identifier of the third network node;
an identifier of at least one radio cell associated with the third network node and to which at least one of the conditions applies;
a coverage area of at least one Synchronization Signal Block (SSB) beam associated with the third network node and to which at least one of the conditions applies,
an identifier of one or more network slices associated with the third network node and to which at least one of the conditions applies.

78. The method of claim 74, wherein:
the one or more conditions are based on one or more measurements or predictions of at least one of the following capacity metrics associated with the third network node: available capacity, Composite Available Capacity (CAC), and transport network capacity; and
each of the one or more conditions relates to a capacity metric for one of the following associated with the third network node: a cell, a Synchronization Signal Block (SSB) beam, a group of SSB beams, a network slice, or a group of network slices.

79. The method of claim 74, wherein:
the one or more conditions are based on one or more measurements or predictions of resource utilization or resource availability at the third network node; and
each of the one or more conditions relates to resource utilization or resource availability for one of the following associated with the third network node: a cell, a Synchronization Signal Block (SSB) beam, a group of SSB beams, a network slice, or a group of network slices.

80. The method of claim 74, wherein:
the one or more conditions are based on one or more measurements or predictions of numbers or types of user devices served by the third network node; and
each of the one or more conditions relates to numbers or types of user devices present in one of the following associated with the third network node: a cell, a Synchronization Signal Block (SSB) beam, a group of SSB beams, a network slice, or a group of network slices.

81. The method of claim 74, wherein the one or more conditions include at least one condition relating to metrics for at least two of the following associated with the third network node: capacity, resource utilization, resource availability, types of user devices, numbers of user devices, hardware utilization, and hardware capacity.

82. The method of claim 74, wherein the status information associated with the third network node comprises one or more of the following: capacity status, load status, resource utilization status, and hardware utilization status.

83. A first network node configured to request a second network node to provide status information associated with a third network node in a wireless communications network, the first network node comprising:
input/output interface configured to communicate with at least the second network node; and
processing circuitry operably coupled to the input/output interface, wherein the processing circuitry and the input/output interface are configured to:
request the second network node to provide status information by transmitting a first request message to the second network node, wherein the first request message indicates one or more conditions whose fulfillment triggers the second network node to provide status information associated with the third network node; and
receive a message from the second network node indicative of one of the following:
an at least partially successful initialization of a conditional forwarding configuration procedure;
status information associated with the third network node, based on fulfillment of at least one of the one or more conditions; or
an unsuccessful or failed initialization of the conditional forwarding configuration procedure.

84. A second network node configured to provide status information associated with a third network node to a first network node in a wireless communications network, the second network node comprising:
input/output interface configured to communicate with at least the first network node; and
processing circuitry operably coupled to the input/output interface, wherein the processing circuitry and the input/output interface are configured to perform the method of claim 74.
